(19) United States
(12) Patent Application Publication
(10) Pub. No.: US 2002/0094823 A1
(43) Pub. Date: Jul. 18, 2002

(54) Radio communication system

(75) Inventors: Muneyuki Suzuki, Tokyo (JP); Yutaka Seki, Sagamihara-shi (JP); Atsushi Nakagawa, Tokyo (JP); Yoshitaka Sioya, Tokyo (JP); Akiyoshi Asami, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/042,159

(22) Filed: Jan. 11, 2002

(30) Foreign Application Priority Data
Jan. 12, 2001 (JP) 5266/2001

(51) Int. Cl. H04Q 7/20

(52) U.S. Cl. 455/456; 455/426; 455/556; 455/41

(57) ABSTRACT

In a radio communication system which is comprised of a plurality of node devices having a radio unit for radio communications in an associated section with a neighboring node device and a management device for managing the respective node devices, the node devices are provided with a GPS device and sends position information about the own node device generated by the GPS device to the management device. The management device generates control information for adjusting an antenna direction and a radio level of the radio unit of the node device according to the position information received from the node device and sends to the node devices, and the node devices performs automatic adjusting control of the antenna direction and the radio level of the own node device according to the received control information.

### BACKGROUND OF THE INVENTION

1. Field of the Invention

The present invention relates to a radio communication system which is comprised of a plurality of node devices having a radio unit for making radio communications in an opposing section with the adjacent node devices and a management device which manages each node device, and more particularly to radio communication system in which each node device has a position measuring function of a GPS (Global Positioning System).

2. Description of the Prior Art

For example, there is known a system which connects a plurality of node devices by a transmission path to form a ring shape, makes communications among the node devices through the transmission path, and also manages each node device located within the ring by a management device disposed outside the ring.

In this case, the transmission path is generally configured of an optical cable or the like, but a system which has the transmission path comprised of a radio link is being proposed today.

This type of system is apt to have a trouble in the opposing radio communication section. For example, a conventional common method, which uses a line clock extracted from a radio communication channel of the opposing section as an internal operation clock of the own device, has disadvantages that synchronization among the respective node devices is lost due to a trouble of the radio communication channel and there is a high risk of having a trouble in the operation of the whole system.

And, it is very important to adjust the direction of an antenna of the radio unit of both node devices between the opposing radio communication section in order to maintain communication quality.

Conventionally, as an antenna direction adjusting method for the ratio unit of the node device, it was common that a maintenance man went up to the top of a building, where an outdoor radio unit to be maintained was disposed, and manually adjusted the direction of the antenna so that the center of the antenna of the radio unit (outdoor unit) of the node device was opposed to the antenna of the radio unit. Thus, the maintenance man is forced to conduct very complex works.

When a radio level of the radio unit of both node devices between the opposing radio communication section is adjusted in addition to the adjustment of the antenna direction is adjusted, it was conventionally common that the maintenance man measures a radio level and works to make the level adjustment using a maintenance terminal or the like according to the measured result, so that the adjusting operation is very troublesome and the adjustment accuracy is also low.

Thus, the conventional system depends on the maintenance man for the adjustment of the antenna direction and radio level of the radio unit of the node device and has disadvantages that the maintenance work is complicated, and the adjustment accuracy of the antenna direction and radio level is low.

Besides, this type of conventional system has disadvantages that the management device is limited its supervisory functions to the display of an occurrence of a trouble in the node device being managed and a type of trouble, so that a geographic arrangement of each node device cannot be located, and the maintenance work cannot be made promptly.

### SUMMARY OF THE INVENTION

A first object of the present invention is to provide a radio communication system which can adjust the radio units of neighboring node devices to a desired communicating state with respect to the mutually opposed radio devices by automatic control from a management device.

A second object of the invention is to provide a radio communication system which can obtain a signal required in order to adjust automatically the mutually opposed radio units to a desired communication state by the existing equipment of the radio units and can avoid complicating the structure.

A third object of the invention is to provide a radio communication system which allows the node devices in the system to accurately operate in synchronization even in case of a trouble in the radio communication channel in the opposing section.

A fourth object of the invention is to provide a radio communication system which can reduce the maintenance work to adjust the antenna direction of the radio unit of the node device and can adjust the antenna direction accurately.

A fifth object of the invention is to provide a radio communication system which can reduce the maintenance work to adjust a radio level of the radio unit of the node device and can adjust the radio level accurately.

A sixth object of the invention is to provide a radio communication system by which the management device can perform the system control including the geographic positions of the respective node devices and promptly corresponds to the maintenance works.

A seventh object of the invention is to provide a radio communication system which can perform the system management including the geographical position of the respective node devices on the side of the management device, recognize easily the connected state of the respective node devices, and quickly deal with the restoration of connection in case of mis-connection.

In order to achieve the aforesaid first object, the invention of claim 1 is directed to a radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein the node device comprises: a GPS device for inputting GPS information which is sent from a GPS satellite and received by a GPS antenna; transmission means for sending position information generated by the GPS device to the management device; and control means for receiving a control signal generated by the management device according to the position information and controlling respective sections of the radio unit according to the control signal; and the management device comprises: control signal generation means which receives the position information from the node device and generates the control signal for controlling respective sections of the node device according to the position information; and control signal transmission means which sends the generated control signal to a pertinent node device.

The invention of claim 2 is directed to the invention described in claim 1, wherein the radio unit is configured of an outdoor device disposed outdoors and an indoor device disposed indoors and connected to the outdoor device through a coaxial cable; the GPS antenna is installed outdoors; and the GPS information received by the GPS antenna is input to the GPS device via the outdoor device, the coaxial cable and the indoor device.

The invention of claim 3 is directed to the invention described in claim 2, wherein the outdoor device comprises multiple separation means which superimposes the GPS information received by the GPS antenna on a communication signal to an adjacent node device and sends to the coaxial cable; and the indoor device comprises multiple separation means which separates the GPS information from the signal being sent through the coaxial cable and inputs to the GPS device.

The invention of claim 4 is directed to the invention described in claim 1, wherein the GPS antenna is installed indoors and the GPS information received by the PGS antenna is directly input to the GPS device.

The invention of claim 5 is directed to the invention described in claim 1, wherein the node device comprises clock generating means which receives a synchronization signal generated by the GPS device from time information which is contained in the GPS information and generates an internal operation clock of the own device according to the synchronization signal.

The invention of claim 6 is directed to the invention described in claim 5, wherein the node device comprises means for generating a self clock and means for extracting a clock from a radio communication channel in an associated section to take it as a line clock; and the clock generation means comprises means for selecting one of the internal operation clock generated from the time information, the self clock and the line clock.

The invention of claim 7 is directed to the invention described in claim 1, wherein the control signal generation means comprises: arithmetic means for calculating a direction of the antenna according to the position information received from each node device so that centers of antennas of the respective radio units of both of the mutually neighboring node devices are faced to each other; and antenna direction adjusting control signal generation means for generating an antenna direction adjusting control signal for adjusting the antennas of the respective radio units of both of the node devices to direct them in the calculated antenna direction; and the control means comprises: antenna direction adjustment means for adjusting the direction of the antenna of the radio unit of the own node device according to the antenna direction adjusting control signal received from the management device.

The invention of claim 8 is directed to the invention described in claim 7, wherein the radio unit has azimuthal direction rotating means and elevational direction rotating means which respectively rotate the antenna in an azimuthal direction and an elevational direction; and the antenna direction adjustment means comprises means for driving the azimuthal direction rotating means and the elevational direction rotating means to respectively rotate the antenna in the azimuthal direction and the elevational direction according to the antenna direction adjusting control signal.

The invention of claim 9 is directed to the invention described in claim 1, wherein the control signal generation means comprises: radio level arithmetic means which calculates an optimum radio level of each radio unit of neighboring node devices corresponding to a distance between the neighboring node devices according to the position information received from the respective node devices; and radio level adjusting control signal generation means which generates a radio level adjusting control signal for adjusting radio levels of the radio units of the neighboring node devices to the calculated radio levels respectively; and the control means comprises radio level adjustment means which adjusts the radio level of the radio unit of the own node device according to the radio level adjusting control signal received from the management device.

The invention of claim 10 is directed to the invention described in claim 9, wherein the radio level is at least either one of the transmission level and the reception level.

The invention of claim 11 is directed to the invention described in claim 1, wherein the management device comprises: a map database which stores electronic map data on an installation area of the node devices; and display control means which displays node icons of the pertinent node devices at the pertinent positions on the electronic map according to the position information received from the node devices.

The invention of claim 12 is directed to the invention described in claim 11, wherein the node device comprises means for sending node identification information about the own device to the management device; and the management device comprises means for displaying the node identification information together with node icons corresponding to the node devices according to the node identification information received from the node devices.

The invention of claim 13 is directed to the invention described in claim 11 or 12, wherein the node device comprises: connection recognition means which recognizes a connected relation between the own node and an adjacent node device; and connected state information transmission means which sends connected state information showing the recognized connected relation to the management device; and the management device comprises: connection management means which manages normal connected relation information between node devices being managed; judging means which compares the connected state information received from the respective node devices and the connected state information managed by the connection management means and judges connected states between the respective node devices; and connected state drawing means which draws lines indicating the connected states of the respective node devices between node icons corresponding to the respective node devices according to the judged result obtained by the judging means.

The invention of claim 14 is directed to the invention described in claim 13, Which further comprises means for alarming a is-connected state when the judging means judges that the respective node devices are in the mis-connected state.

The invention of claim 15 is directed to the invention described in claim 1, wherein the node device is an ATM communication device for communicating by an asynchronous transfer mode (ATM) transmission system, and the entire network is configured by an ATM network.

According to the inventions of claims 1 to 15, the node device sends the position information generated by the GPS device to the management device, which then determines a positional relationship between both of the node devices in the associated section according to the position information received from the node device, generates control information for controlling the respective sections of the radio units of both of the node devices according to the positional relationship and sends it to the node device, then the node device controls the respective sections of the own node device according to the control information received from the management device. Therefore, the respective node devices can automatically control the antenna direction, radio level and the like of the radio unit of the own device to a desired operating state for the associated radio communications with the neighboring node device according to the positional relationship with the neighboring node devices.

In order to achieve the aforementioned second object, the invention of claim 16 is directed to a radio communication system which disposes a plurality of node devices each provided with a radio unit which includes an outdoor device installed outdoors and an indoor device installed indoors and connected to the outdoor device through a coaxial cable and, realizes communications between the respective node devices as the respective node devices perform radio communications with neighboring node devices; wherein: the node device comprises a GPS device which inputs GPS information sent from a GPS satellite and received by a GPS antenna; the GPS antenna is installed outdoors; and the GPS information received by the GPS antenna is input to the GPS device through the outdoor device, the coaxial cable and the indoor device.

The invention of claim 17 is directed to the invention described in claim 16, wherein the outdoor device comprises multiple separation means which superimposes the GPS information received by the GPS antenna on a communication signal with the neighboring node device and sends to the coaxial cable; and the indoor device comprises multiple separation means which separates the GPS information from the signal being sent through the coaxial cable and inputs to the GPS device.

According to the inventions of claims 16 and 17, the GPS antenna is disposed outdoors, the GPS information sent from the PSG satellite is received through the GPS antenna and input to the GPS device through the outdoor device of the radio unit, the coaxial cable and the indoor device of the radio unit. Therefore, in order to take the GPS information received through the GPS antenna into the GPS device, it is not necessary to dispose a cable dedicated for transmission of the GPS information between the outdoor device and the indoor device, and the wiring structure can be simplified.

In order to achieve the aforesaid third object, the invention of claim 18 is directed to a radio communication system which disposes a plurality of node devices having a radio unit and performs radio communications of the respective node devices with their neighboring node devices to realize the communications among the respective node devices, wherein: the node device comprises: a GPS device which inputs GPS information received from a GPS satellite; and clock generation means which generates an internal operation clock of the own device according to a synchronization signal generated from time information contained in the GPS information by the GPS device.

The invention of claim 19 is directed to the invention described in claim 18, wherein the node device comprises means for generating a self clock and means for extracting a clock from a radio communication channel between associated sections to take as a line clock; and the clock generating means comprises means for selecting either one of the internal operation clock generated from the time information, the self clock and the line clock.

According to the aforesaid invention of claim 18, in order to generate the clock for the internal operation of the own device by the node device according to the synchronization signal generated by the GPS device using the time information received from the GPS satellite, the respective node devices in the system comprised of the plurality of node devices having the clock generating function can operate accurately in synchronization with a single GPS synchronization signal.

According to the invention of claim 19, it is configured to enable the selection of one among the line clock extracted from the radio communication channel in the associated section, the self clock supplied from the clock generating means of the own device and the clock generated according to the synchronization signal generated by the GPS device, so that a minimum communication operation of the node device can be maintained using the line clock and the self clock even if a clock based on the synchronization signal cannot be obtained due to a reception failure or the like from the GPS satellite.

In order to achieve the aforesaid fourth object, the invention of claim 20 is directed to a radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein the node device comprises: a GPS device which inputs GPS information received from a GPS satellite; transmission means which sends position information generated by the GPS device to the management device; and antenna direction adjusting means which adjusts a direction of the antenna of the radio unit of the own node device according to antenna direction adjusting control signal generated by the management device according to the position information; and the management device comprises: arithmetic means which calculates directions of the antennas according to the position information received from the respective node devices so that centers of the antennas of the respective radio units of both of the mutually neighboring node devices are faced to each other; antenna direction adjusting control signal generation means which generates the antenna direction adjusting control signal for adjusting the antennas of the respective radio units of both of the node devices to face them in the calculated antenna direction; and control signal transmission means which sends the generated antenna direction adjusting control signal to the pertinent node devices.

The invention of claim 21 is directed to the invention described in claim 20, wherein the radio unit has azimuthal direction rotating means and elevational direction rotating means which respectively rotate the antenna in an azimuthal direction and an elevational direction; and the antenna direction adjustment means comprises means for driving the azimuthal direction rotating means and the elevational direction rotating means to respectively rotate the antenna in the azimuthal direction and the elevational direction according to the antenna direction adjusting control signal.

According to the inventions of claims 20 and 21, the node device sends the position information generated by the GPS device to the management device, which then generates antenna direction adjusting control information for adjusting the antenna direction of the radio unit of both the node devices in the opposing section according to the position information received from the node device and sends to the node devices. Besides, the node device adjusts the antenna direction of the radio unit of the own node device based on the antenna direction adjusting control information received from the management device, so that the antenna directions of both of the node devices in the associated radio communication section can be adjusted automatically, and a labor of the worker who adjusts the antenna direction can be reduced considerably.

In order to achieve the aforementioned fifth object, the invention of claim 22 is directed to a radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein: the node device comprises: a GPS device which inputs GPS information received from a GPS satellite; transmission means which sends position information generated by the GPS device to the management device; and radio level adjusting means which adjusts a radio level of the radio unit of the own node device according to a radio level adjusting control signal generated by the management device according to the position information; and the management means comprises: radio level arithmetic means which calculates an optimum radio level of the respective radio units of both of the node devices corresponding to a distance between both of the node devices according to the position information received from the respective node devices; radio level adjusting control signal generation means which generates the radio level adjusting control signal for adjusting the radio levels of the radio units of both of the node devices to the calculated radio level respectively; and control signal transmission means which sends the generated antenna direction adjusting control signal to the pertinent node devices.

The invention of claim 23 is directed to the invention described in claim 22, wherein the radio level is at least either one of the transmission level and the reception level.

According to the inventions of claims 22 and 23, the node device sends the position information about the node device generated by the GPS device to the management device, which then generates radio level adjusting control information for adjusting the radio level of the radio unit of both the node devices in the associated section based on the position information received from the node device and sends to the node device. Besides, the node device adjusts the radio level of the radio unit of the own node device based on the radio level adjusting control information received from the management device, so that the radio level (at least one of the transmission level and the reception level) of both of the node devices in the associated radio communication section can be adjusted automatically, and a labor of the worker who adjusts the radio level can be reduced, and the adjusting accuracy can also be improved.

In order to achieve the aforementioned sixth object, the invention of claim 24 is directed to a radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein: the node device comprises: a GPS device which inputs GPS information received from a GPS satellite; and transmission means which sends position information generated by the GPS device to the management device; and the management device comprises: a map database which stores electronic map data on an installation area of the node devices; and display control means which displays node icons of the pertinent node devices at pertinent positions on the electronic map according to the position information received from the node devices.

The invention of claim 25 is directed to the invention described in claim 24, wherein the node device are further comprises means for transmitting node identification information on the own device to the management device; and the management device comprises means for displaying the node identification information together with node icons corresponding to the node devices according to the node identification information received from the node devices.

According to the invention of the aforesaid claim 24, the node device sends the position information about the node device generated by the GPS device to the management device, which then indicates the node icon of the node device at the relevant position on the electronic map based on the position information received from the node device, so that the part of the management device can know the graphical arrangement of the respective node devices by seeing the node icon indication, and the efficiency of the maintenance task can be improved.

According to the invention of claim 25, the node devices transmit the node identification information about the own device to the management device, and the management device displays the node identification information on the node icons corresponding to the node devices according to the node identification information received from the node devices, so that the respective node devices can be identified easier.

In order to achieve the aforementioned seventh object, the invention of claim 26 is directed to a radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein: the node device comprises: a GPS device which inputs GPS information received from a GPS satellite; connection recognition means which recognizes a connected relation between the own node and the adjacent node devices; transmission means which transmits position information generated by the GPS device and connected state information showing a connected relation recognized by the connection recognition means to the management device; the management device comprises: a map database which stores electronic map data about an installation area of the node devices; display control means which displays-node icons of the pertinent node devices at the pertinent positions on the electronic map according to the position information received from the node devices; connection management means which manages normal connected relation information between the node devices being managed; judging means which compares the connected state information received from the respective node devices and the connected state information managed by the connection management means and judges connected states between the respective node devices; and connected state drawing means which draws lines indicating the connected states of the respective node devices between the node icons corresponding to the respective node devices according to the judged result obtained by the judgment means.

The indention of claim 27 is directed to the invention described in claim 26, wherein the node device further comprises means for transmitting node identification information about the own device to the management device; and the management device comprises means for displaying the node identification information together with the node icons corresponding to the pertinent node devices according to the node identification information received from the node devices.

The invention of claim 28 is directed to the invention described in claim 26 or 27, further comprising means for alarming a mis-connected state when the judging means judges that the respective node devices are in the mis-connected state.

According to the inventions of claims 26 to 28, the node device sends the position information about the node device generated by the GPS device and the connected state information indicating the connected state with the adjacent node device to the management device, which then displays the node icons of the pertinent node devices at the pertinent positions on the electronic map on the basis of the position information received from the node devices, and also displays lines indicating the connected state among the respective node devices among the node icons corresponding to the respective node devices based on the connected state information received from the node device. Thus, it can be seen accurately whether not only the geographical arrangement of the node devices but also the connection of the node devices are normal or defective, and if the connection is defective, a reconnection work can be made promptly.

### BRIEF DESCRIPTION OF THE DRAWING

FIG. 1 is a block diagram showing a general structure of a radio communication system to which the present invention pertains;

FIG. 2 is a diagram showing a communication image of the radio communication system to which the present invention pertains;

FIG. 3 is a diagram showing a GPS antenna installation mode to which a first embodiment pertains;

FIG. 4 is a block diagram showing the functional structure of each section in the GPS antenna installation mode of FIG. 3;

FIG. 5 is a diagram showing the GPS antenna installation mode to which a modified example of the first embodiment pertains;

FIG. 6 is a block diagram schematically showing a structure of the node device to which a second embodiment pertains;

FIG. 7 is a block diagram showing the structure of a clock generating section of the node device to which the second embodiment pertains;

FIG. 8 is a diagram showing the structure of a radio unit of the node device to which a third embodiment pertains;

FIGS. 9(a) to 9(c) are diagrams showing an external structure of an outdoor device of the radio unit to which the third embodiment pertains;

FIG. 10 is a block diagram showing the structure of NMS to which the third embodiment pertains;

FIG. 11 is a diagram showing the structure of a radio unit of the node device to which a fourth embodiment pertains;

FIG. 12 is a block diagram showing the structure of NMS to which the fourth embodiment pertains;

FIG. 13 is a block diagram showing the structure of NMS to which a fifth embodiment pertains;

FIG. 14 is a diagram showing an example node icon display by NMS to which the fifth embodiment pertains;

FIG. 15 is a block diagram showing the structure of NMS to which a sixth embodiment pertains;

FIG. 16 is a diagram showing an example node icon display by NMS to which the sixth embodiment pertains;

FIGS. 17(a) to 17(c) are diagrams illustrating a mis-connection judging process by NMS to which the sixth embodiment pertains; and

FIGS. 18(a) and 18(b) are diagrams showing example node icon displays at a normal connection judgment and a mis-connection judgment.

### DESCRIPTION OF THE PREFERRED EMBODIMENTS

Embodiments of the present invention will be described in detail with reference to the accompanying drawings.

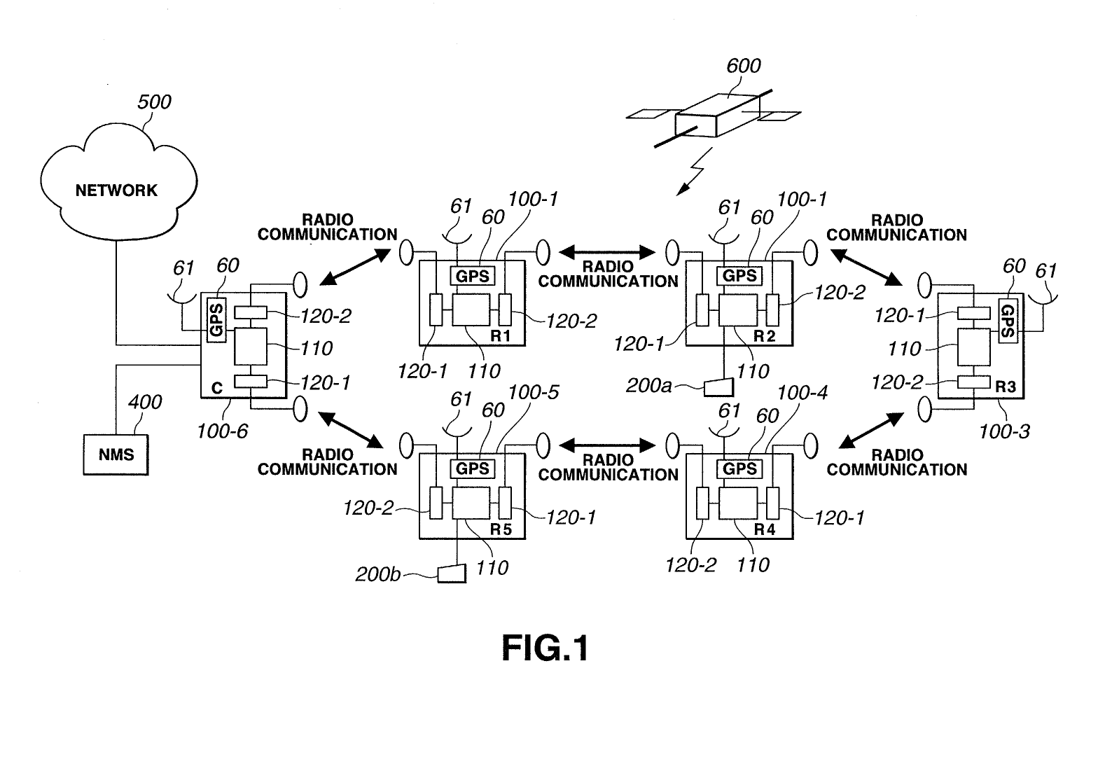

FIG. 1 is a block diagram showing a general structure of the communication system to which the present invention pertains. This system is predicated on a ring network system which communicates with a plurality of node devices, which are dispersed at necessary positions, connected in the shape of a ring, and comprised of a plurality of node devices 100 [ring node devices 100-1(R1), 100-2(R2), 100-3(R3), 100-4(R4), 100-5(R5), center node device 100-6(C)] and network management system (NMS) 400.

The respective node devices 100 (R1, R2, R3, R4, R5 and C) are provided with radio units 120-1, 120-2 to make radio communications between the neighboring opposed node devices 100 via the radio units 120-1, 120-2.

In this case, the respective radio units 120-1, 102-2 of the opposed node devices 100 are connected by two-way wireless links. One of the links is used as an operating line for normally sending information within the ring as described later, while the other is used as a reserve line for securing a detour transmission path to be used in case of a trouble in any radio communication section.

In the system of FIG. 1, for example, an asynchronous transfer mode (ATM) method is used as a transmission method between the node devices 100. In this case, in the system, the respective node devices 100 and the NMS 400 are implemented by ATM communication device, and the transmission path (associated radio communication channel) is implemented as an ATM cell is transmitted.

In an ATM transmission path capable of setting a virtual communication line in two levels such as VP (Virtual Path) and VC (Virtual Channel), the ATM communications device has ability to perform exchange processing of a cell (ATM cell) having a fixed length, which is input from an input port, to an output port according to VPI (Virtual Path Identifier) and VCI (Virtual Channel Identifier) contained in the ATM cell.

In the ring of the system shown in FIG. 1, communications such as data transmission can be made between predetermined node devices 100 or a single or plurality of communication terminals 200 (200a, 200b) connected to each node device 100 by the aforementioned ATM exchange processing ability which is possessed by each node device 100.

In the example shown in FIG. 1, the communication terminal 200a connected to R2 and the communication terminal 200b connected to R5 are typically shown, but a single or plurality of local communication terminals 200 can be also connected to other R1, R3, R4 and C.

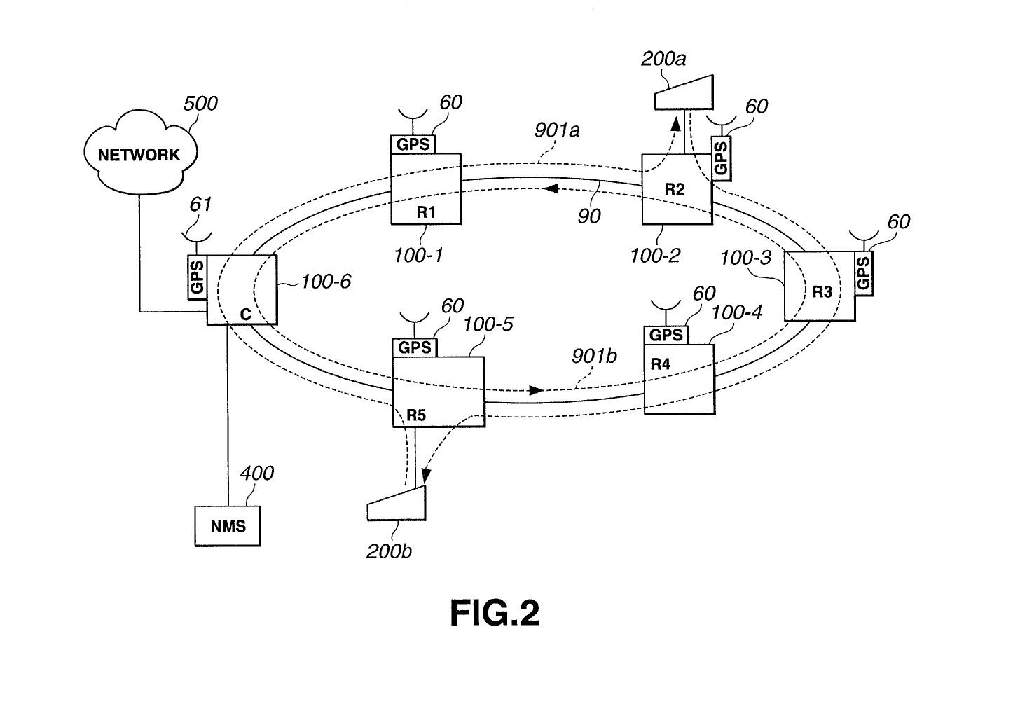

FIG. 2 is a diagram showing a communication image of communications made between the communication terminal 200a connected to the R2 and the communication terminal 200b connected to the R5 in the system of FIG. 1.

In FIG. 2, transmission path 90 is implemented by two-way radio communication channels among the respective node devices 100 in FIG. 1. In this example, communication path 901a (clockwise path toward the drawing) corresponding to the operating radio link and communication path 901b (counterclockwise path toward the drawing) corresponding to the reserve radio link are provided in the transmission path 90.

Prior to the communications between the communication terminals 200a and 200b, switching information (input PORT, VPI, VCI, output PORT) capable of forming the communication path 901a is set in the respective node devices 100 which are disposed along the transmission path 90 between the communication terminals 200a and 200b.

During the communications between the communication terminals 200a and 200b, the respective node devices 100 refer to the aforementioned switching information to control for exchange output of the ATM cell, which is input from the communication path 901a to the input port of ATM switch section, to an output port according to VPI and VCI contained in the cell.

Thus, data from the communication terminal 200a is transmitted clockwise from R2 in order of R3→R4→R5 through the communication path 901a and sent from the R5 to the communication terminal 200b.

Data from the communication terminal 200b is transmitted clockwise from the R5 in order of C→R1→R2 through the communication path 901a and sent from the R2 to the communication terminal 200a.

At this time, R2 and R5 become the node devices 100 which are mutually associated through the communication path 901a and respectively perform the sending side operation to convert SMT (Synchronous Transfer Mode) data from the communication terminals 200a, 200b connected to an own node into an ATM cell and to send to the communication path 901a, and the receiving side operation to decompose the cell received from the communication path 901a into STM data which is before the conversion and to send to the pertinent communication terminals 200a, 200b connected to the own node.

Thus, the two-way communications between the communication terminal 200a and the communication terminal 200b are enabled by the above control. By the same communication procedure, two-way communications can be made mutually between the communication terminal 200 to be connected to another R in the ring and the communication terminal 200 to be connected to still another R through a communication path virtually set between them.

And, if a trouble occurs in a certain associated radio communication section in the ring during the data transmission by the operating communication path 901a, the associated Rs which are adjacent to the failure part perform loop back control to make loopback-connection of the operating communication path 901a to the reserve communication path 90lb. Thus, a detour transmission path is secured by the operating communication path 901a and the reserve communication path 901b to maintain communications.

In the system of FIG. 1, the two-way data transmission can be made by the ATM method between the node devices 100 configuring the ring and between predetermined communication terminals 200 connected to the respective node devices 100.

In the system of FIG. 1, C100-6 in the ring is connected to the NMS 400 and communication network 500.

Accordingly, the respective node devices 100 and the respective communication terminals 200 connected to the respective node devices 100 can also communicate with, for example, an ATM communication device in another ATM ring network or a data terminal connected to the ATM communication device through the external communication network 500 connected to C100-6.

Supervisory and control information can also be sent or received between the respective node devices 100 and the NMS 400 via the C100-6. Thus, the NMS 400 can provide services to collect information from the respective node devices 100 via the C100-6 to monitor the operating conditions and the like and to send a control signal through a reverse route based on the monitored result to control the respective node devices 100 in the ring.

To control the respective node devices 100 from the NMS 400, a control path not shown in FIG. 2 is set in addition to the aforementioned communication paths 901a, 901b between the NMS 400 and the respective node devices 100. This control path is virtually set in the transmission path 90 in the same manner as the aforementioned communication paths 901a, 901b.

Besides, this system (see FIG. 1) has GPS device 60 mounted on the node devices 100 (R1, R2, R3, R4, R5 and C) respectively.

The GPS device 60 has ability to receive time information, a range signal and the like, which are sent from GPS satellite 600, through GPS antenna 61, receives a synchronization signal on the basis of, for example, the time information among the received signals, or generates position information from the range signal as described later in detail.

First Embodiment

As a first embodiment, a specific installation mode of the GPS antenna 61, by which the GPS device 60 which is provided for each node device 100 receives a signal from the GPS satellite 600, will be described.

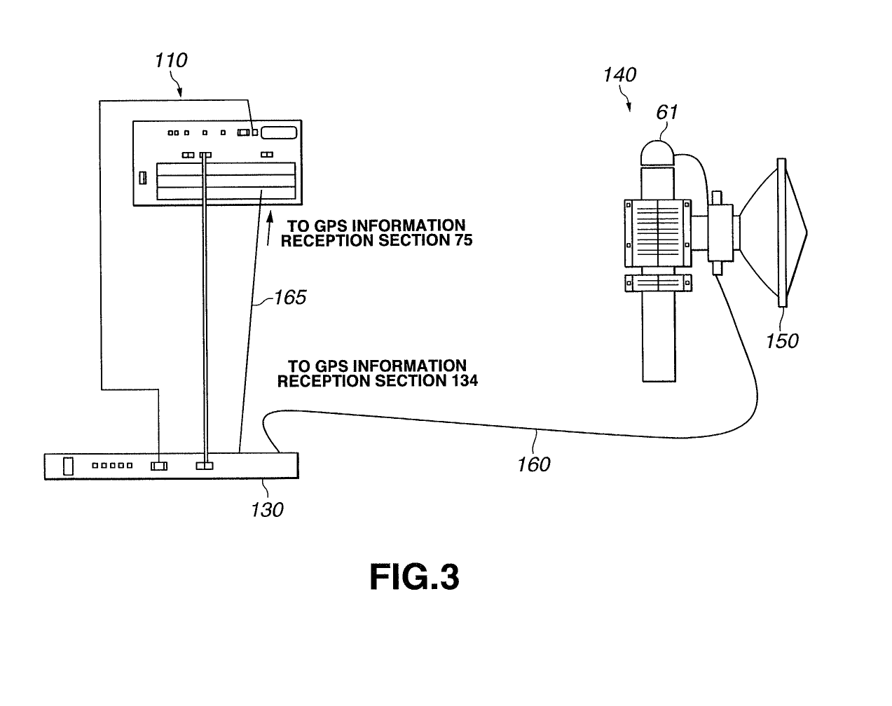

FIG. 3 is a conceptual diagram showing an example of the installation mode of the GPS antenna 61 to which this embodiment pertains.

In FIG. 3, communication device 110, indoor unit (IDU) 130 and outdoor unit (ODU) 140 are component elements of each node device 100 of FIG. 1.

Among them, the IDU 130 and the ODU 140 are component elements of the radio unit 120 of each node device 100. The IDU 130 is disposed together with the communication device 110 indoor, e.g., in a building or the like, and the ODU 140 is disposed outside the building or the like.

The example of FIG. 3 shows a mode that the GPS antenna 61 is mounted in proximity (on the tip of a pole supporting the antenna 50) to the antenna 150 of the ODU 140 which is one of the component elements of the radio unit 120 of each node device 100, namely outdoors.

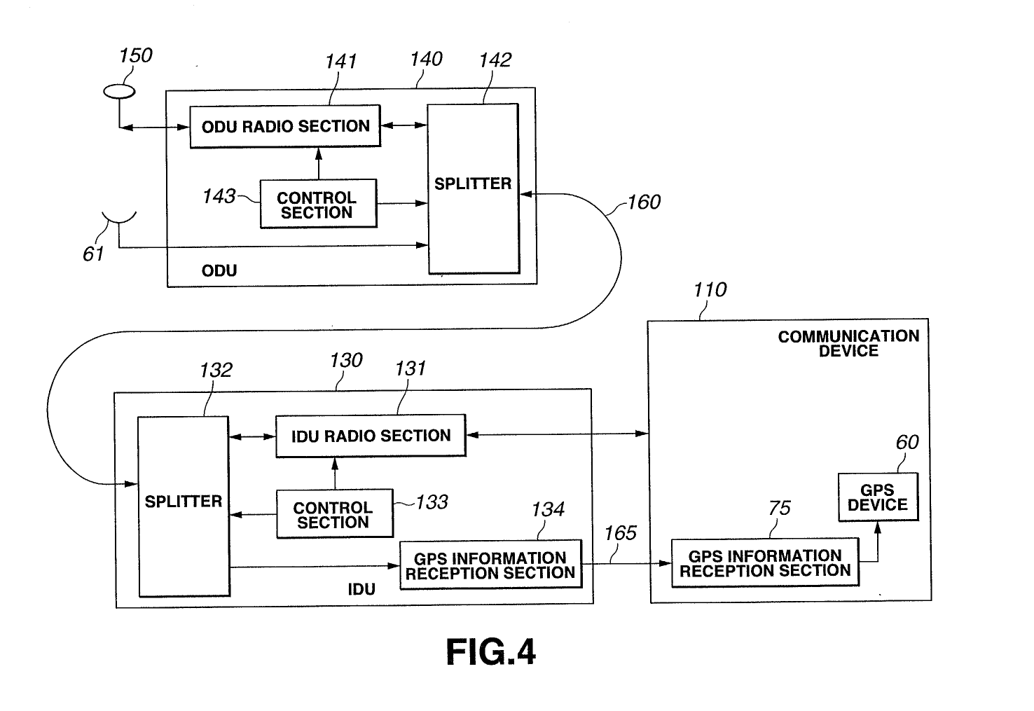

FIG. 4 is a block diagram showing a detailed structure of each section in the antenna installation mode shown in FIG. 3.

In FIG. 4, the IDU 130 is comprised of IDU radio section 131, splitter 132, control section 133 and GPS information receiving section 134. The ODU 140 is comprised of ODU radio section 141, splitter 142 and control section 143. The communication device 110 is provided with at least the GPS device 60 and the GPS information receiving section 75.

The GPS antenna 61 disposed outdoor in the mode shown in FIG. 3 is connected to the splitter 142 in the ODU 140 through a GPS antenna cable.

The splitter 142 of the ODU 140 and the splitter 132 of the IDU 130 are mutually connected through coaxial cable 160. In the IDU 130, the GPS information receiving section 134 is connected to the splitter 132.

And, the GPS information receiving sectionl34 in the IDU 130 and the GPS information receiving section 75 in the communication device 110 are mutually connected through GPS information transmission path 165. Besides, another end of the GPS information receiving section 75 is connected to the antenna input terminal of the GPS device 60 in the communication device 110.

In the above configuration, information (GPS information: time information to which a second embodiment to be described later pertains, a range signal to which a third embodiment pertains, etc.) which is received through the GPS antenna 61 from the GPS satellite 600 is superimposed to a main signal by the splitter 142 of the ODU 140 and sent to the IDU 130 through the coaxial cable 160.

The IDU 130 distributes the aforementioned GPS information which is received through the coaxial cable 160 to the GPS information receiving section 134 by the splitter 132 and transmits to the GPS information receiving section 75 of the communication device 110 through the GPS information transmission path 165.

The communication device 110 inputs the GPS information, which is sent from the GPS information receiving section 134 of the IDU 130, to the antenna input terminal of the GPS device 60 via the GPS information receiving section 75.

Besides, the GPS device 60 performs signal processing such as reception of a synchronization signal, generation of position information, etc. on the basis of the input GPS information.

Thus, the first embodiment is configured to send and receive GPS information using the multiple separation means (splitter 132) in the IDU 130 of the radio unit 120, the multiple separation means (splitter 142) in the ODU 140 and the coaxial cable 160 between them.

According to this structure, even when the GPS antenna 61 is disposed outdoor, wiring from the IDU 130 to the outdoor GPS antenna 61 can be replaced by the coaxial cable 160 for sending and receiving the main signal or the like between the IDU 130 and the ODU 140, and the wiring structure can be simplified by omitting the wiring (special cable for transmission of GPS information) between them.

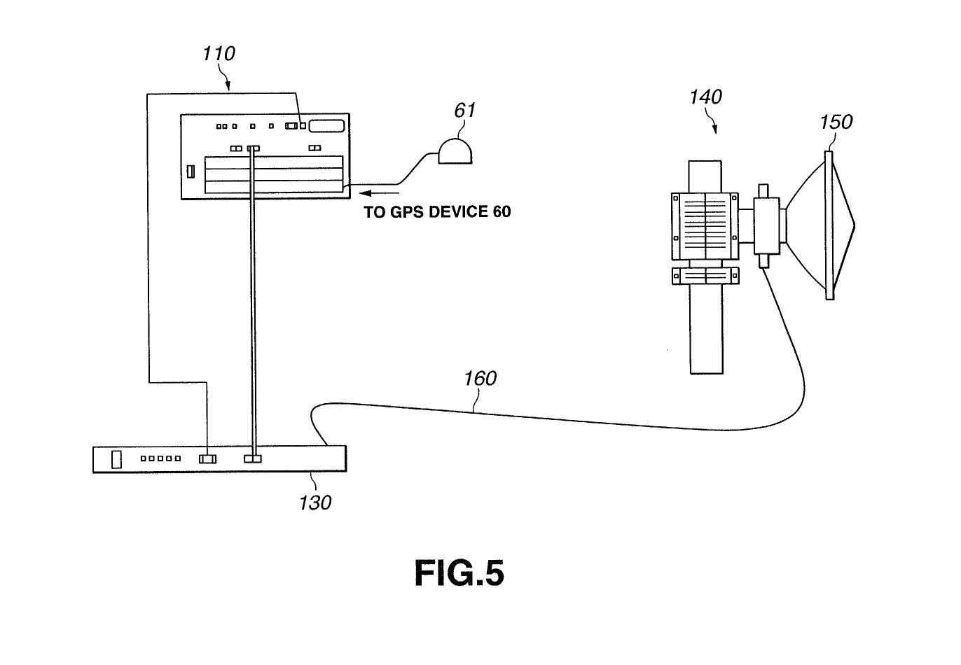

FIG. 5 is a conceptual diagram showing an installation mode of the GPS antenna 61 to which a modification of the first embodiment pertains. In this modification, there is shown a mode that the GPS antenna 61 is disposed within a building where the communication device 110 is disposed.

In this case, the GPS antenna 61 can be connected directly to the antenna input terminal of the GPS device 60 in the communication device 110, its connecting work is simple, and no special additional device is required.

Second Embodiment

A second embodiment will be described. In the second embodiment, information taken through the GPS antenna 61 described in the first embodiment is used to generate a clock of the node device 100.

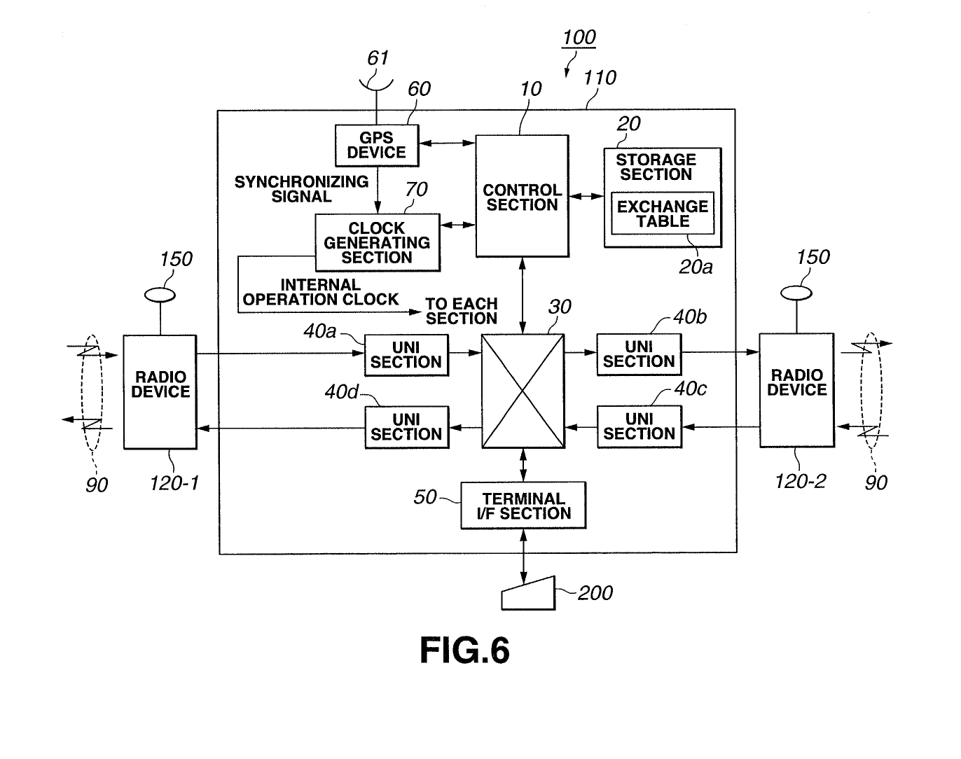

FIG. 6 is a block diagram showing a schematic structure of the node device 100 to which the second embodiment pertains.

The node device 100 is comprised of control section 10, storage section 20, ATM switch section 30, user network interfaces (UNI sections) 40a, 40b, 40c, 40d, terminal interface (I/F) section 50, GPS device 60 and clock generation section 70.

The control section 10 controls to switch between ports of the switch section 30 according to switching information (input PORT, VPI, VCI, output PORT, etc.) set in exchange table 20a in the storage section 20 to make a cell exchange between the UNI sections 40a, 40b, 40c, 40d and the terminal I/F section 50.

The UNI sections 40a, 40b, 40c, 40d control the interface with transmission path 90 between the neighboring node devices 100. According to the invention, the transmission path 90 is realized by the aforementioned two-way radio links.

Thus, the UNI sections 40a, 40b among the UNI sections 40a, 40b, 40c, 40d perform interface processing with, for example, a clockwise radio link via the radio units 120-1, 120-2, and the UNI sections 40c, 40d perform interface processing with a counterclockwise radio link via the radio units 120-2, 120-1, respectively.

The terminal I/F section 50 controls the interface with the communication terminal 200, and specifically converts STM data from the communication terminal 200 connected to the own node into an ATM cell, and performs a transmission operation to send to the transmission path 90 and a reception operation to decompose the cell received from the transmission path 90 into STM data before the conversion and to send to the pertinent communication terminal 200 connected to the own node.

Then, the synchronous control of the node device 100 of this embodiment will be described.

In the node device 100 of this embodiment, the GPS device 60 has ability to receive time information from the GPS satellite 600 through the GPS antenna 61 and to convert the time information into a synchronization signal.

This embodiment is configured to directly connect the GPS antenna (see FIG. 6) to the communication device 110 but may be configured to dispose the GPS antenna 61 outdoors to input the GPS information received through the GPS antenna 61 to the GPS device 60 through the ODU 140, the coaxial cable 160 and the IDU 130 as described in the first embodiment.

The synchronization signal generated by the GPS device 60 is input to the clock generating section 70. The clock generating section 70 generates an internal operation clock according to the synchronization signal and supplies to the respective sections in the own node device 100.

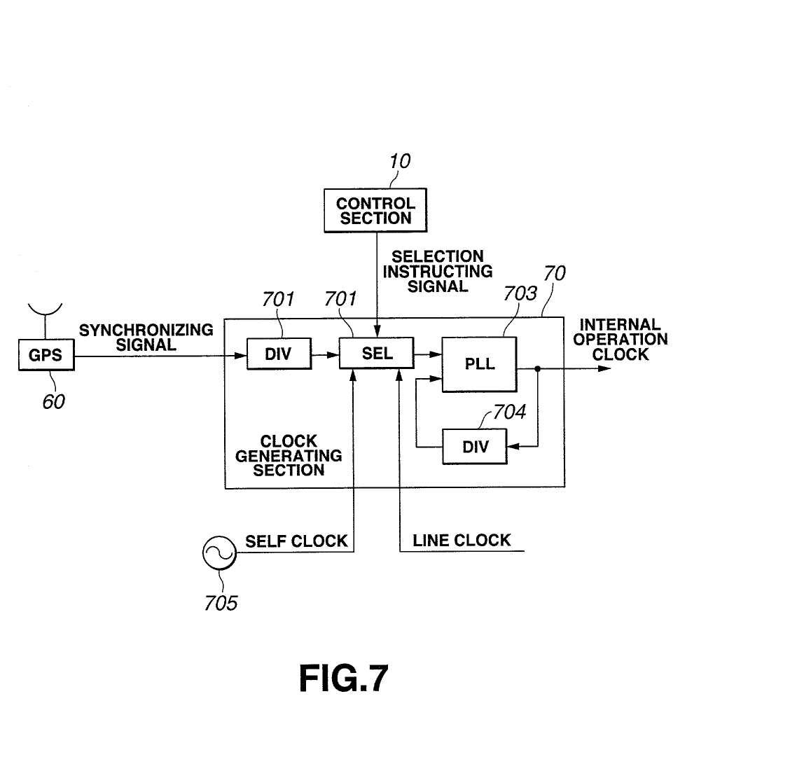

FIG. 7 is a block diagram showing a functional structure of the clock generating section 70 of the node device 100 to which this embodiment pertains.

This clock generating section 70 is comprised of frequency divider (DIV) 701, selector (SEL) 702, phase lock loop (PLL) circuit 703 and frequency divider (DIV) 704.

In FIG. 7, the synchronization signal input from the GPS device 60 is divided by the frequency divider 701 and output as a clock lowered to a speed (frequency) of the internal operation clock of the node device 100.

The aforementioned clock which is output from the frequency divider 701 is input to the selector 702. In addition to the clock from the frequency divider 701, a self clock from clock oscillation source 705 and a line clock extracted from the radio communication channel of the ring to which the own node device 100 is connected are input to the selector 702.

The selector 702 selects one of the aforementioned input clocks according to, for example, a selection instruction signal from the control section 10 of the node device 100 and inputs to the PLL circuit 703.

The PLL circuit 703 supplies the clock input from the selector 702 as an internal operation clock to the respective sections of the node device 100. At the time, the frequency divider 704 serves to divide the output clock of the PLL circuit 703 and return the clock back to the input of the PLL circuit 703.

In this embodiment, the output clock of the frequency divider 701 is normally selected by the selector 702.

This clock has been obtained by dividing the synchronization signal generated on the basis of the time information received by the GPS device 60 from the GPS satellite 600. Therefore, the internal operation clock based on a single piece of time information sent from the GPS satellite 600 is supplied from the clock generation section 70 to the respective sections of the node device 100.

The respective sections of the node device 100 operate according to the internal operation clock given from the clock generating section 70.

Similarly, by generating the internal operation clock in synchronization with the time information sent from the GPS satellite 600 in the clock generating section 70 of each of the other node devices 100, all the node devices 100 within the ring operate in synchronization with a single piece of time information being sent from the GPS satellite 600, and they can operate in the fully synchronized state with one another.

If input of the synchronization signal from the GPS satellite 60 is interrupted by any trouble, a selection instructing signal is sent from the control section 10 having detected the trouble to the selector 702, for example a line clock is selected by the selector 702, and the clock generated by the PLL circuit 703 based on the line clock is supplied as an internal operating clock.

At this time, if the clock generation section 70 of each of the other node devices 100 has also selected a line clock, each node device 100 in the ring can operate in synchronization with a single line clock.

Besides, if the synchronization signal from the GPS device 60 and also the line clock are cut off, a self clock is selected by the selector 702, and a clock generated by the PLL circuit 703 based on the selected self clock is supplied as an internal operation clock.

In this case, the node device 100 might not be fully synchronized with another node device 100, but a minimum communication function can be maintained without stopping the operation of the node device 100.

The clock generating function of the aforementioned GPS device 60 according to the synchronization signal can be configured as an interface board of the communication device 110 in addition to a mode of mounting as the clock generating section 70 in the node device 100 as shown in FIG. 6 and FIG. 7.

Thus, the second embodiment is configured that the clock generating function according to the synchronization signal from the GPS device 60 is disposed in the node device 100, and the clock generated by that function is supplied as an internal operation clock of the node device 100.

By the above configuration, accurate synchronization control reflecting the time information about the GPS satellite 600 can be made among the node devices 100 in the ring, and it contributes to the improvement of communication reliability.

Third Embodiment

A third embodiment will be described. In the third embodiment, the node device 100 uses information taken through the GPS antenna 61 and controls to adjust the direction (an azimuth angle and an elevation angle) of the antenna of the pertinent node device 100.

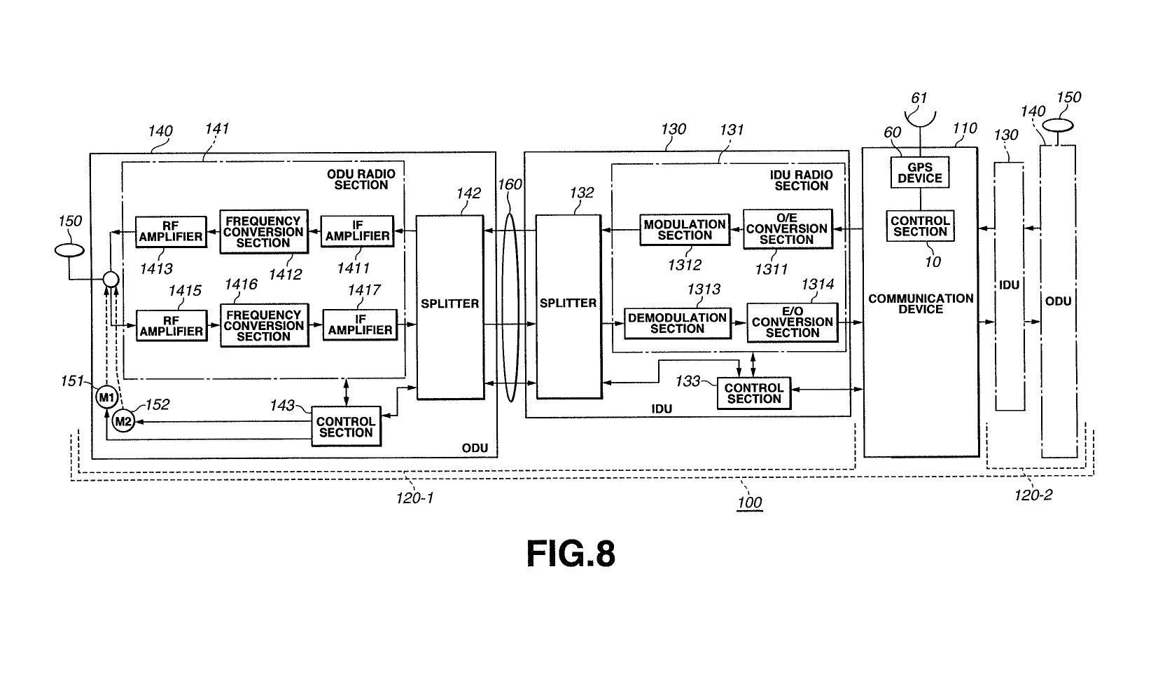

FIG. 8 is a block diagram showing a structure of the radio units 120 (120-1, 120-2) of the node device 100 to which the third embodiment pertains.

In FIG. 8, the radio units 120-1, 120-2 each are comprised of IDU 130 and ODU 140 and connected to either side of the communication device 110 which is the main body of the node device 100.

In the radio units 120 (120-1, 120-2), the IDU 130 is comprised of IDU radio section 131, splitter 132 and control section 133, and the ODU 140 is comprised of ODU radio section 141, splitter 142, control section 143, antenna 150 and antenna drive motors (M1) 151, (M2) 152.

The IDU radio section 131 and the ODU radio section 141 are mutually connected by coaxial cable (IF cable) 160 and send or receive a main signal such as communication data and a control signal through the coaxial cable 160. At that time, the splitter 132 of the IDU 130 and the splitter 142 of the ODU 140 perform superimposition and distribution of the aforementioned main signal and control signal.

Thus, as to the main signal, the main signal (e.g., the signal that the radio unit 120-2 has received from the radio unit 120-1 of the associated node device 100) output from the communication device 110 is converted from an optical signal into electrical signal by O/E conversion section 1311 in the IDU radio section 131 of the IDU 130 and then modulated by modulation section 1312. The modulated signal is converted into an intermediate frequency (IF) and sent from the splitter 132 to the ODU 140 through the coaxial cable 160.

In the ODU 140, the main signal sent from the IDU 130 is input to IF amplifier 1411 via the splitter 142 and amplified, converted into a radio frequency (RF) by frequency conversion section 1412, further amplified by RF amplifier 1413, and sent to the associated node device 100 through the antenna 150.

And, the ODU 140 receives the signal through the antenna 150 from the radio unit 120-2 of the opposing node device 100 and inputs to RF amplifier 1415. The received signal amplified by the RF amplifier 1415 is converted into an intermediate frequency (IF) by frequency converting section 1416, amplified by IF amplifier 1417 and sent from the splitter 142 to the IDU 130 through the coaxial cable 160.

The IDU 130 inputs the main signal sent from the ODU 140 to demodulation section 1313 via the splitter 132 to demodulate it, converts from the electrical signal into an optical signal by E/O conversion section 1314 and sends to the communication device 110.

For example, the control signal from the communication device 110 to the ODU 140 is superimposed on the main signal through the control section 133 and the splitter 132 of the IDU 130, sent to the ODU 140 through the coaxial cable 160, distributed by the splitter 142 in the ODU 140 and sent to the control section 143.

Conversely, the control signal from the control section 143 of the ODU 140 to the radio unit 120 is superimposed on the main signal via the control section 143 and the splitter 142, sent to the IDU 130 through the coaxial cable 160, distributed to the control section 133 by the splitter 132 in the IDU 130 and sent to the communication device 110.

Besides, the node device 100 (see FIG. 8) to which this embodiment pertains is provided with the motors 151 (M1), 152 (M2) for driving the antenna 150 in the ODU 140 in order to control the adjustment of the direction of the antenna 150.

And, in this node device 100, the same GPS device 60 as the one described in the first and second embodiments is disposed in the communication device 110 and connected to the GPS antenna 61. The detailed structure of the communication device 110 conforms to, for example, the one shown in FIG. 6.

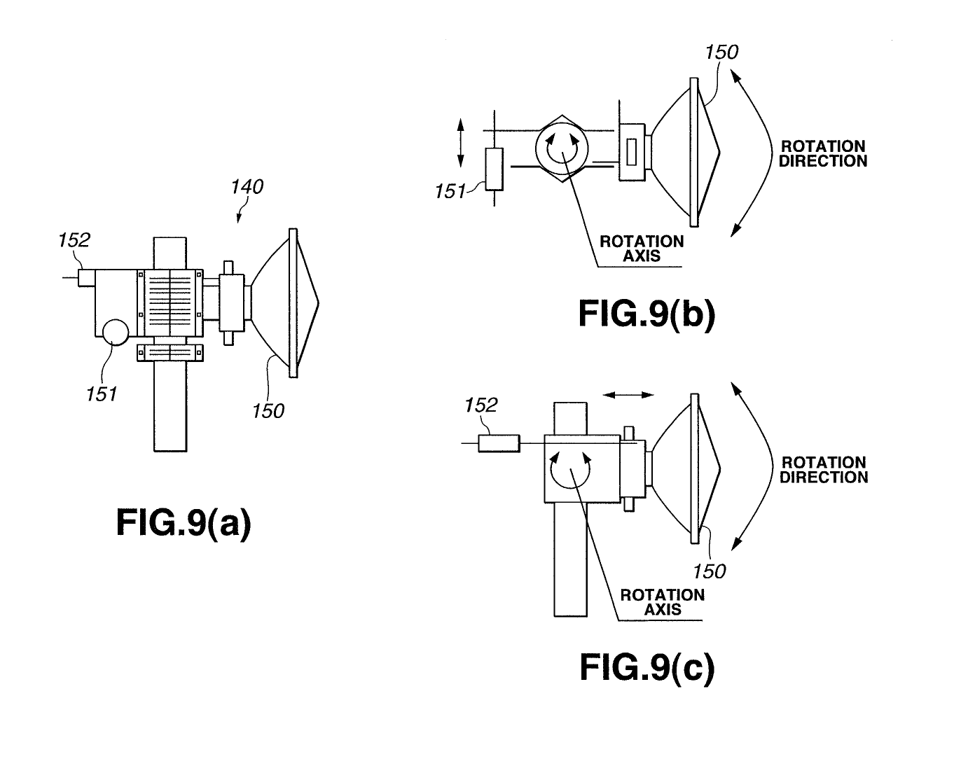

FIGS. 9(a) to 9(c) are diagrams showing an outside structure of the ODU 140 to which this embodiment pertains. FIG. 9(a) is an side appearance diagram, FIG. 9(b) is a conceptual top diagram of FIG. 9(a), and FIG. 9(c) is a conceptual side diagram of FIG. 9(a).

The motor 151 is an azimuth adjusting motor which has a function of rotating the antenna 150 horizontally (a horizontal direction: a direction of an azimuth angle) as shown in FIG. 9(b). The motor 152 is an elevation adjusting motor which has a function of rotating the antenna vertically (a perpendicular direction: a direction of an elevation angle) as shown in FIG. 9(c).

These motors 151, 152 can be driven to rotate the antenna 150 horizontally or vertically by an appropriate angle to adjust the antenna 150 to any direction (an azimuth angle and an elevation angle).

In the node device 100 configured as described above, the GPS device 60 (see FIG. 8) which is disposed next to the communication device 110 uses the signal (range signal) received from the GPS satellite 600 to measure a distance between this device (GPS device 60) and the GPS satellite 600, determines the position of this device (the pertinent node device 100) according to the obtained distance information and inputs the position information (east longitude, west longitude, above sea level, etc.) to the control section 10.

The control section 10 sends the position information from the GPS device 60 to the NMS 400 via the ATM switch section 30, the UNI section 40 and the radio unit 120. At that time, the control section 10 sets the aforementioned virtual path to reach the NMS 400 and forms the position information into a cell to send it through the virtual path. The radio unit 120 sends the celled position information as the main signal by the method described referring to FIG. 8.

Besides, the respective node devices 100 in the ring between the sender node device 100 and the NMS 400 relay the cell sent from the sender node device 100 to the adjacent node device 100 by the aforementioned method.

Similarly, each of the other node devices 100 in the ring also sends the position information generated by the GPS device 60 in the each node devices 100 to the NMS 400.

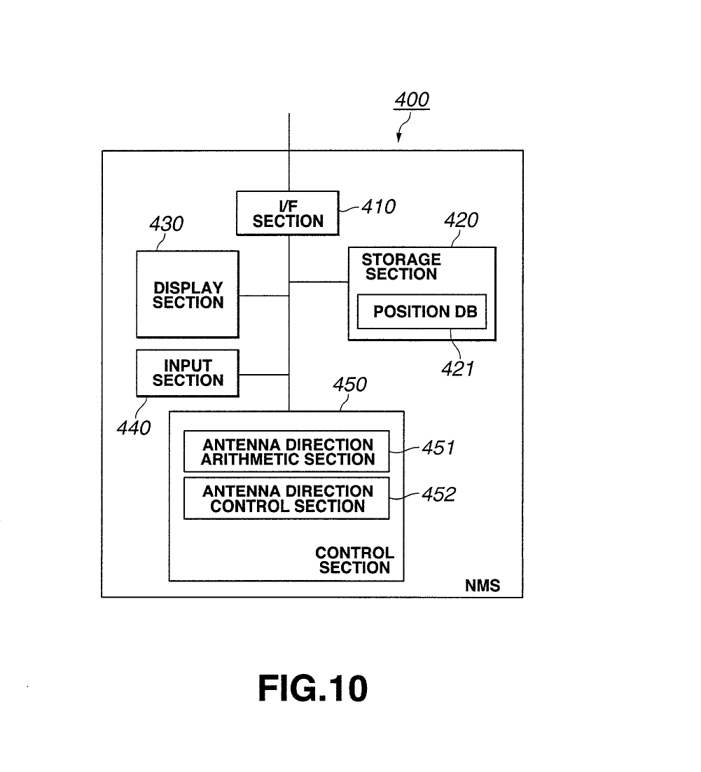

Meanwhile, the NMS 400 to which this embodiment pertains is comprised of the interface (I/F) section 410, storage section 420, display section 430, input section 440 and control section 450 as shown in FIG. 10.

The storage section 420 is provided with position database (DB) 421. The control section 450 is provided with antenna direction arithmetic section 451 and antenna direction control section 452.

In the NMS 400 configured as described above, position information being sent from the respective node devices 100 is received via the I/F section 410 under control of the control section 450 and stored in the position DB 421 of the storage section 420 for each node device 100.

Then, the antenna direction arithmetic section 451 of the control section 450 reads position information about two node devices 100 in the associated section from the position DB 421 and calculates a direction of the antennas 150 of both of the node devices 100 according to the position information.

The antenna direction to be calculated here is a direction (an azimuth angle and an elevation angle) of each antenna 150 for mutually associating the antennas 150 of the respective radio units 120 of both of the node devices 100 in a state that their centers are not displaced.

Besides, the antenna direction control section 452 of the control section 450 generates control information (antenna direction adjustment instruction information) for adjusting the antenna 150 of the pertinent node device 100 to the antenna direction according to the antenna direction of the each node devices 100 calculated by the antenna direction arithmetic section 451.

Then, the antenna direction control section 451 sends the generated antenna direction adjustment instruction information to each of the pertinent node devices 100 through a route opposite to the aforementioned position information reception route.

Meanwhile, the respective node devices 100 (see FIG. 8) receive the aforementioned control information being sent from the NMS 400 by the radio unit 120 to take it into the control section 10 via the UNI section 40 and the ATM switch section 30. At this time, the pertinent control information received by the antenna 150 is handled as the main signal within the radio unit 120 and delivered from the ODU 140 to the communication device 110 via the IDU 130.

Then, the control section 10 of the communication device 110 sends the antenna direction adjustment instruction information received from the NMS 400 to the ODU 140 through the aforementioned control information transmit/receive route, namely through the control section 133 and the splitter 132 of the IDU 130 and the coaxial cable 160. The ODU 140 distributes the control information by the splitter 142 and takes into the control section 143.

Then, the control section 143 of the ODU 140 drives the azimuth adjusting motor 151 and the elevation adjusting motor 152 according to the control information (the antenna direction adjustment instruction information from the NMS 400) received from the control section 10 of the communication device 110 to control to align the antenna 150 with the instructed antenna direction (an azimuth angle and an elevation angle).

Thus, the each node device 100 sends the position information generated by the GPS device 60 based on the signal received from the GSP satellite 600 to the NMS 400 in the third embodiment, while the NMS 400 calculates an antenna direction (an azimuth angle and an elevation angle) according to the position information received from the each node device 100 so that the centers of the antennas 150 of the two neighboring node devices 100 in the associated section are faced to each other, generates a control signal for adjusting the pertinent antennas 150 to face the direction determined by the aforementioned arithmetic and sends the signal to the pertinent node devices 100. And the node devices 100 control the adjustment of the direction of the antenna 150 of the radio unit 120 of the each node device according to the control signal received from the NMS 400.

According to the aforementioned structure, the adjustment of the directions of the antennas 150 of both node devices 100 in the associated radio communication section can be automated, and a labor of the worker in charge of adjusting the antenna direction of the node device 100 can be reduced considerably as compared with a conventional way of adjusting the antenna direction with reference to a map or visually.

In this embodiment, transmission of position information from the node device 100 to the NMS 400 and transmission of control information from the NMS 400 to each node devices 100 are performed using the aforementioned control path determined between the pertinent node device 100 and the NMS 400. This transmit/receive method of the position information and the control information is common to the respective embodiments to be described later.

Fourth Embodiment

A fourth embodiment will be described. In the fourth embodiment, the node device 100 uses the information taken through the GPS antenna 61 to control the adjustment of the radio level of the node device 100.

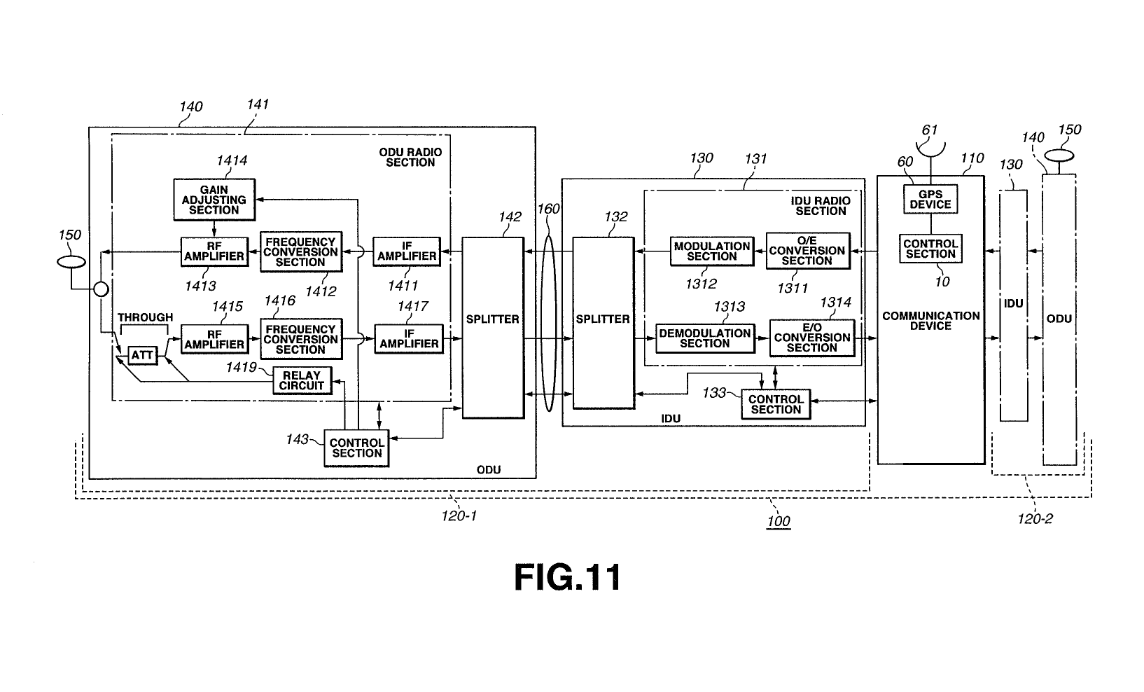

FIG. 11 is a block diagram showing a structure of the radio units 120 (120-1, 120-2) of the node device 100 to which the fourth embodiment pertains.

In FIG. 11, like reference numerals are used to indicate sections which performs the same functions as the node device 100 (see FIG. 8) to which the third embodiment pertains.

It is apparent from FIG. 11 that the node device 100 according to this embodiment is not provided with the antenna driving motors (M1) 151, (M2) 152 which are provided for the node device 100 of the third embodiment but provided with a structure for dealing with the radio level adjusting control.

Specifically, as a structure to deal with the radio level adjusting control, gain adjusting section 1414 for adjusting a gain of the RF amplifier 1413 in a transmission route of the ODU radio section 141 is disposed within the ODU 140 of the node device 100. Besides, attenuator (ATT) 1418 and relay circuit 1419 which controls to turn on/off the ATT 1418 are disposed between the RF amplifier 1415 in a reception route of the ODU radio section 141 and the antenna 150.

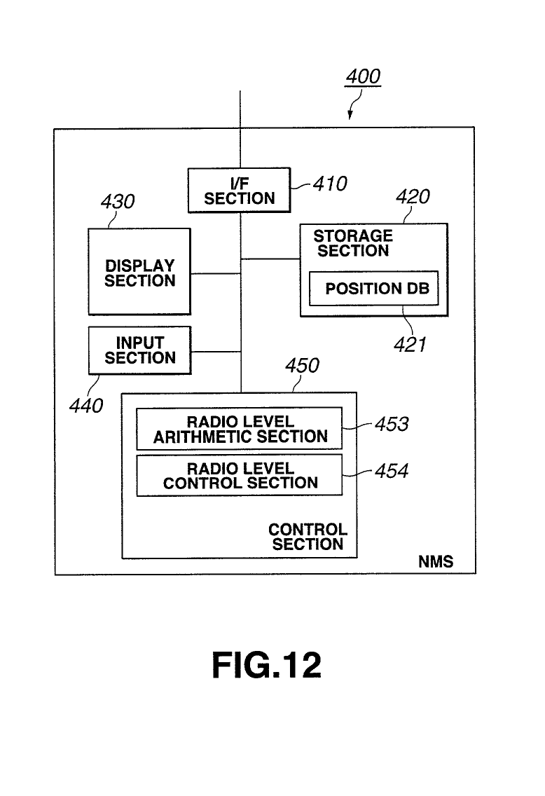

Meanwhile, the NMS 400 to which this embodiment pertains has the structure as shown in FIG. 12. It is apparent from FIG. 12 that the MNS 400 according to this embodiment is configures with the antenna direction arithmetic section 451 and the antenna direction control section 452 removed from the control section 450 of the NMS 400 (see FIG. 10) according to the third embodiment and provided with radio level arithmetic section 453 and radio level control section 454.

In this embodiment, each node device 100 generates position information by the GPS device 60 from the ranging signal received from the GPS satellite 600 and sends the position information to the NMS 400 in the same way as in the third embodiment.

Meanwhile, the NMS 400 (see FIG. 12) receives the position information being sent from each node device 100 via the I/F section 410 and stores in position DB 421 of storage section 420 for each node device 100.

Then, the radio level arithmetic section 453 of the control section 450 reads the position information about the two node devices 100 in the associated section from the position DB 421, determines a distance between the pertinent node devices 100 based on the position information, and calculates an optimum radio level of each of the pertinent node devices 100 with respect to the distance between both of the node devices 100.

In this embodiment, the transmission level and the reception level of the pertinent node devices 100 are calculated in the radio level arithmetic section 453, but it may be configured to calculate at least one of them.

However, both of the node devices 100 whose radio level is calculated are mutually faces with each other with the aforementioned radio communication section between them, and the transmission level of one of the node devices 100 is disposed to affect on the reception level of the other node device 100, so that it is necessary to calculate the reception and transmission levels considering the transmission and reception levels of the associated node device.

And, the node device 100 used for this type of system tends to have an error in data due to a drop in radio reception level if the radio reception level is excessively low and tends to have an error in data due to the saturation of the receiver if the radio reception level is excessively high. Therefore, such points must be considered to determine the aforementioned optimum radio level.

Besides, the radio level control section 454 of the control section 450 generates control information (transmission level adjustment instruction information and ATT on/off instruction information) for adjusting the radio level of the pertinent node device 100 to the pertinent radio level based on the radio level of the respective node devices 100 calculated by the radio level arithmetic section 453. And, the control information generated is sent to the respective node devices 100 through a route which is reverse to the route for receiving the aforementioned position information.

Meanwhile, the respective node devices 100 (see FIG. 6) receive the aforementioned control information being sent from the NMS 400 by the radio unit 120 and temporarily take into the control section 10 via the UNI section 40 and the ATM switch section 30.

At this time, the radio unit 120 (see FIG. 11) handles the control information received through the antenna 150 as the main signal and delivers if from the ODU 140 to the communication device 110 via the IDU 130.

Then, the control section 10 of the communication device 110 sends the control information received from the NMS 400 to the ODU 140 through the aforementioned control information transmit/receive route, namely through the control section 133 and the splitter 132 of the IDU 130 and the coaxial cable 160 in FIG. 11. In the ODU 140, the control information is distributed by the splitter 142 and taken into the control section 143.

Then, the control section 143 of the ODU 140 drives gain adjusting section 1414 according to the transmission level adjustment instruction information among the control information (instruction information from the NMS-400) received from the control section 10 of the communication device 110 to control the transmission output level of the RF amplifier 1413 to the instructed transmission output level.

And, the control section 143 drives relay circuit 1419 according to the ATT on/off instruction information among the instruction information from the NMS 400 to control the attenuator 1418 to the instructed state (on or off state).

Thus, each node device 100 sends the position information generated by the GPS device 60 according to the signal received from the GPS satellite 600 to the NMS 400 in the fourth embodiment. Meanwhile, the NMS 400 calculates a radio level conforming to a distance between the two neighboring node device 100 in the associated section according to the position information received from the respective node devices 100 and adjusts the radio transmission level and the radio reception level of the radio unit 120 according to the calculated result.

By configuring as described above, the adjustment of the radio level of both of the node devices 100 in the associated radio communication section can be automated, a labor of the worker in charge of the radio level adjustment can be reduced and the adjustment accuracy can be improved as compared with a conventional manner that the worker adjusts the radio level manually according to the measured result obtained by a measuring device.

Fifth Embodiment

A fifth embodiment will be described. In the fifth embodiment, it is controlled to determine position information about the node device 100 using information taken through the GPS antenna 61 and to show on the NMS 400.

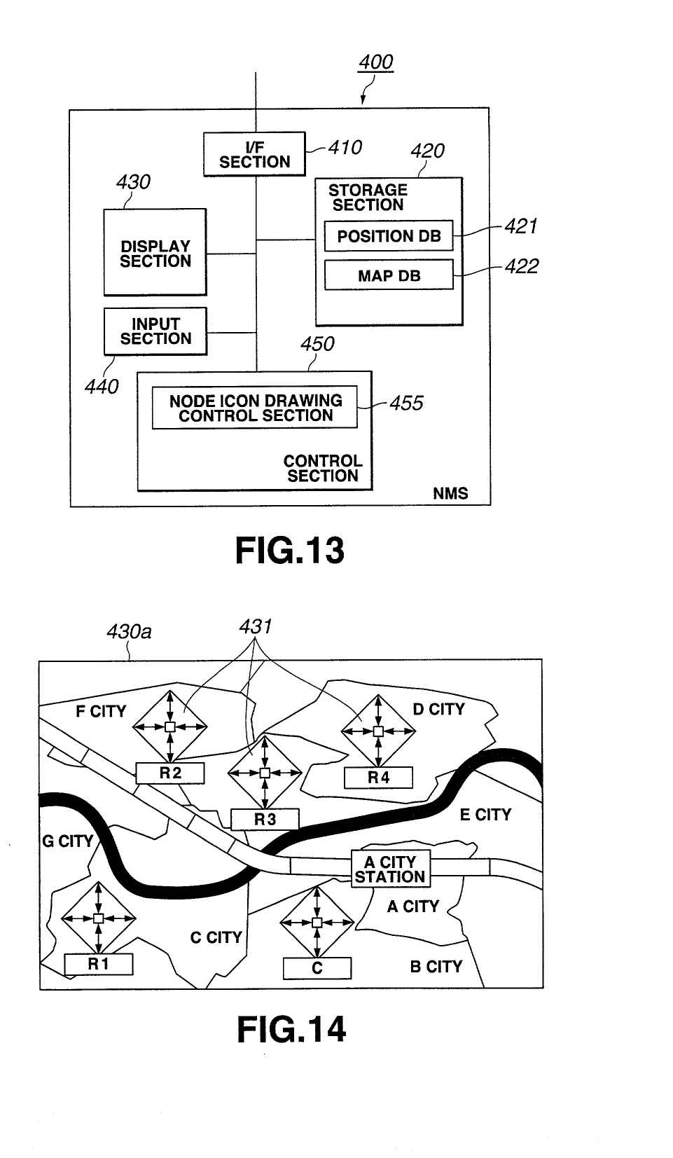

FIG. 13 is a block diagram showing a functional structure of the NMS 400 to which the fifth embodiment pertains.

The NMS 400 is comprised of interface (I/F) section 410, storage section 420, display section 430, input section 440 and control section 450. The storage section 420 has position database (DB) 421 and map database (DB) 422, and the control section 450 has node icon drawing control section 455.

The position DB 421 stores position information being sent from the respective node devices 100 in association with node information about the respective node devices.

The map DB 422 stores electronic map data on an installation area of the node device 100 under management.

It is apparent from the aforementioned component elements of the NMS 400 that a structure of the node device 100 to which this embodiment pertains needs to have a function of sending node identification information such as node device number or the like of the won node device when the pertinent position information is sent in addition to means for sending the position information generated by the GPS device 60 according to the signal received from the GPS satellite 600 to the NMS 400 in the same was as in the aforementioned embodiment.

In this embodiment, as to the function of sending a node identification number of the own node device 100 to the NMS 400, for example the number of the own device may be stored in the storage section 20 in FIG. 6, and the control section 10 may add the node device number when the position information is sent.

In contrast to the structure and operation of the node device 100, the NMS 400 operates as follows.

First, the NMS 400 receives the position information and node identification information being sent from each node device 100 via the I/F section 401 under control of the control section 450 and stores the position information and node identification information in the position DB 421 of the storage section 420 for each node device 100.

When a node icon drawing instruction is input from the input section 440, the node icon drawing control section 455 of the control section 450 controls to read map data on the installation area of the respective node devices under management from the map DB 422 to show on the display section 430 and to generate node icons of the respective node devices 100; and also controls to read position information about the respective node devices 100 from the position DB 421 and to show the node icons corresponding to the respective node devices 100 at the corresponding positions in the map being shown according to the position information.

At this time, the node icon drawing control section 455 reads node identification information about the respective node devices 100 from the position DB 421 and displays the pertinent node identification information together with the node icons corresponding to the pertinent node devices 100.

FIG. 14 shows an example indication of the node icon display screen of the NMS 400 of this embodiment.

It is seen from FIG. 14 that node icons 431 corresponding to the respective node devices 100 are accurately shown at positions on the map shown by the NMS 400 and node identification information such as C, R1, R2 are also shown with the respective node icons 431.

Thus, according to the fifth embodiment, the NMS 400 stores and manages the position information received from the respective node devices 100 to be managed, generates node icons corresponding to the respective node devices 100 and displays the pertinent node icons together with the node numbers or the like at the pertinent positions on the electronic map according to the position information about the pertinent node devices 100, so that the system manager on the side of the NMS 400 can easy know where the respective node devices 100 are by simply seeing the display screen, and a labor for maintenance can be saved.

Sixth Embodiment

A sixth embodiment will be described. In the sixth embodiment, a connection line between the respective node devices 100 is also shown in addition to the node icons shown in the fifth embodiment.

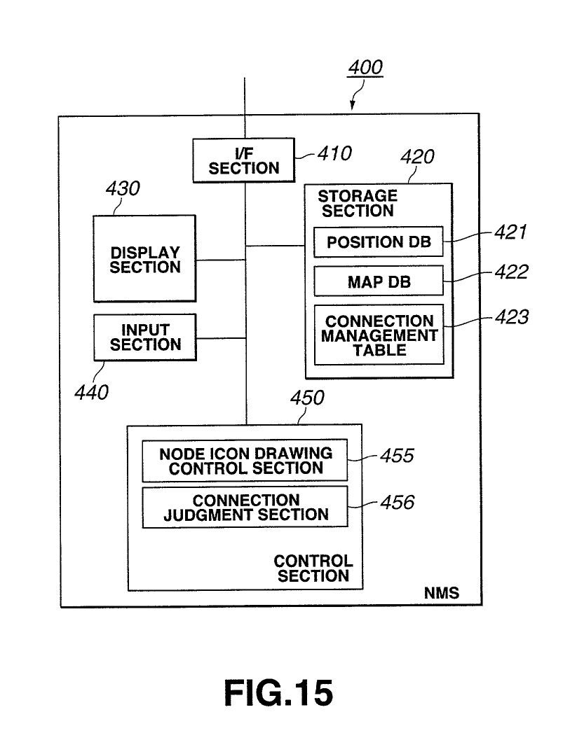

FIG. 15 is a block diagram showing a functional structure of the NMS 400 to which the sixth embodiment pertains.

The NMS 400 is comprised of interface (I/F) section 410, storage section 420, display section 430, input section 440 and control section 450, and the storage section 420 is provided with position database (DB) 421, map database (DB) 422 and connection management table 423. The control section 450 is provided with node icon drawing control section 455 and connection judgement section 456.

The position DB 421 stores the position information being sent from the respective node devices 100 in association with the node information about the respective node devices.

The map DB 422 stores electronic may data on the installation area of the node devices 100 being managed.

The connection management table 423 stores connection relations (connected state information), which correspond to the normal connected state of each node device 100 according to this embodiment, in association with the connection ports.

In addition, the storage section 420 also secures a reference area (not shown) for storing information, which is compared with the contents of the connection management table 423, namely a connection relation corresponding to the normal connected state of the respective node devices 100 according to this embodiment.

It is seen from the aforementioned component elements of the NMS 400 that the structure on the side of the node device 100 according to this embodiment is required to have means from sending to the NMS 400 the position information generated by the GPS device 60 according to the signal received from the GPS satellite 600 in the same way as in the fifth embodiment and a function of additionally sending node identification information such as node device number or the like of the own node device when the pertinent position information is transmitted.

Besides, the node device 100 according to this embodiment needs to have a function of recognizing the neighboring node devices 100 on both sides and connected to two connection ports (P1), (P2) of the own node and sending its connection relation to the NMS 400.

Among the node devices 100, to recognize the node devices 100 connected to the connection ports P1, P2, for example it may be configured that a polling signal is sent through the respective ports, the node device number being sent from the associated node device 100 in response to the polling signal is received, and it is judged which node device 100 is connected. And, the judged result may be sent as node connected state information together with the aforementioned position information and node identification information to the NMS 400.

The NMS 400 performs the following operation with respect to the structure and operation of the node device.

First, the NMS 400 receives the position information, node identification information and connected state information being sent from each node device 100 under control of the control section 450 via the I/F section 410, and stores the position information and node identification information in the position DB 421 of the storage section 420 for each node device 100.

In the aforementioned received information, the connected state information is stored in the reference area which is provided in the connection management table 423 of the storage section 420.

When the node icon drawing instruction is input from the input section 440, the node icon drawing control section 455 of the control section 450 controls to read map data on the installation area of the respective node devices 100 being managed from the map DB 422 to display it on the display section 430, to generate node icons of the respective node devices 100, and to read position information about the respective node devices 100 from the position DB 421 of the storage section 420 and to show node icons corresponding to the pertinent node devices 100 at the pertinent positions on the displayed map according to the position information.

At this time, the node icon drawing control section 455 reads node identification information about each node device 100 from the position DB 421 and displays the pertinent node identification information on the node icon corresponding to the pertinent node device 100.

The connection judging section 456 of the control section 450 compares connected state information indicating the normal connection set from the connection management table 423 of the storage section 420 with the connected state information collected from each node device 100 stored in the reference area to judge a connected state between the respective node devices 100.

Besides, the node icon drawing control section 455 draws a line to indicate the connected state between the pertinent node icons of the respective node icons in the current display according to the connection judged result obtained by the connection judgement section 456.

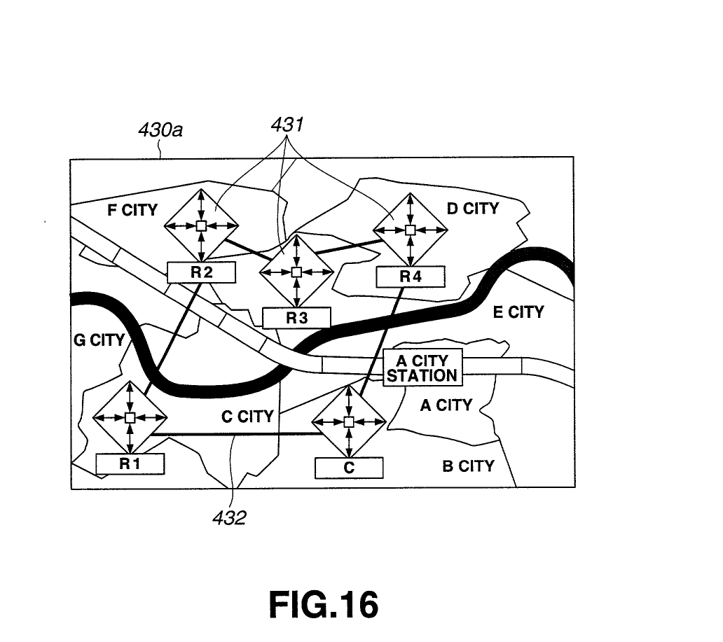

FIG. 16 shows an example of node icon display screen 430a according to the node icon drawing control section 455 of this embodiment. It is seen that the node icons 431 corresponding to the respective node devices 100 are shown together with node device numbers (C, R1, R2, . . . ) at the pertinent positions on the map, and the respective node icons 431 are shown in a state mutually connected by the line 432 to indicate a connected state which conforms to the actual connected state among the respective node devices 100.

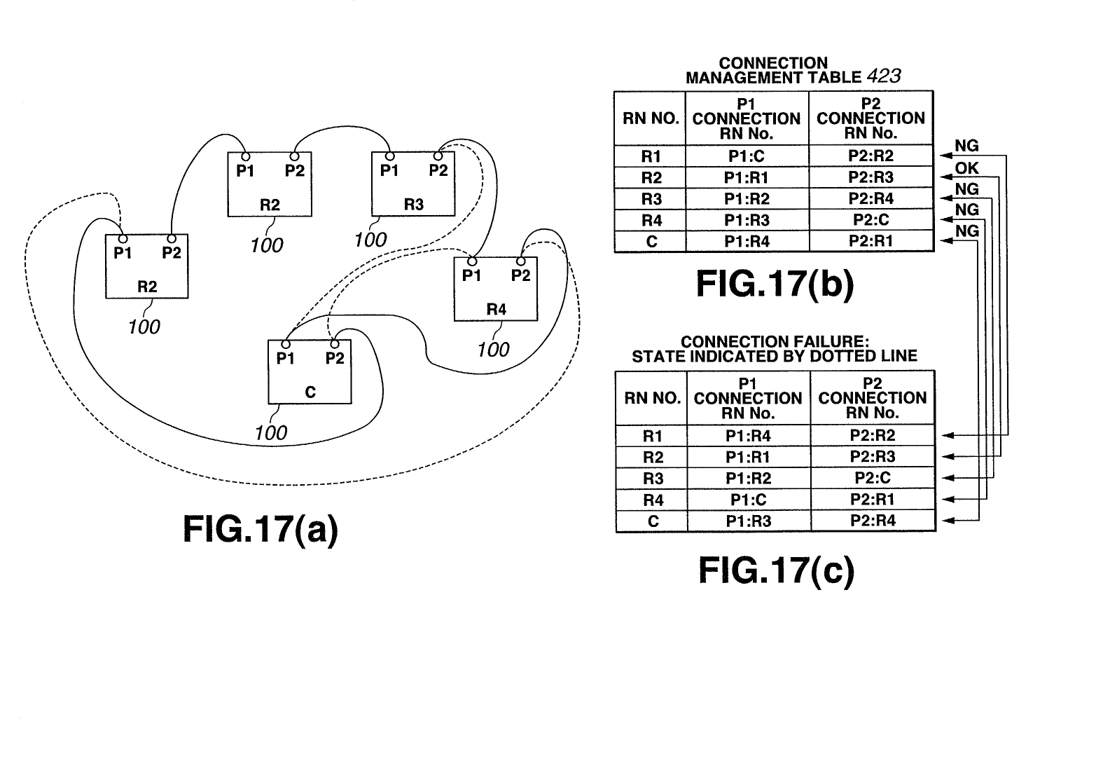

Then, connection judgment processing involved in the display of the node icons according to this embodiment will be described with reference to FIGS. 17(a) to 17(c).

FIG. 17(a) is a diagram schematically showing the arrangement and connected relation of the node devices 100 (C, R1 to R4) subjected to the connection judgment, wherein a solid line indicates a normal connected state, and a dotted line indicates a mis-connected state.

In the normal connected state, port P1 of a certain node device 100 is connected to port P2 of its adjacent node device 100 and its port P2 is connected to port P1 of another adjacent node device 100. But, it is to be understood that the aforementioned connection is made through the radio communication channel.

A relation between the connection ports P1, P2 of the own device and the number of the adjacent node device connected to it is previously stored with the contents as shown in FIG. 17(b) for all node devices under management in the connection management table 423 of the storage section 420.

Here, it is assumed that each node device 100 is placed in a mis-connected state as indicated by a dotted line in FIG. 17(a) with respect to the normal connected state managed by the connection management table 423.

In this case, the pertinent node device 100 collects information about the node devices 100 connected to the connection ports P1, P2 of the own device and sends the information about the connected adjacent node devices 100 to the NMS 400 as connected state information associated with the identification number and connection port number of the own device.

The NMS 400 receives the connected state information and stores in the management table reference area in the storage section 420.

And, the connection judgment section 456 compares the connected state information stored in the reference area with the connected state information stored in the connection management table 423 and judges whether the connection is normal or not depending on whether they agree or not.

In the mis-connected state indicated by the dotted line in FIG. 17(a), the connected state information in the reference area has the contents as shown in FIG. 17(c).

Thus, when compared with the connected state information in the normal connected state shown in FIG. 17(b), all ring nodes other than R2 are judged to be mis-connected.

In this case, the node icon drawing control section 455 draws line 432, which connects the respective node icons 431 in a mode corresponding to the connected state judged as the mis-connection, on the node icon display screen 430a.

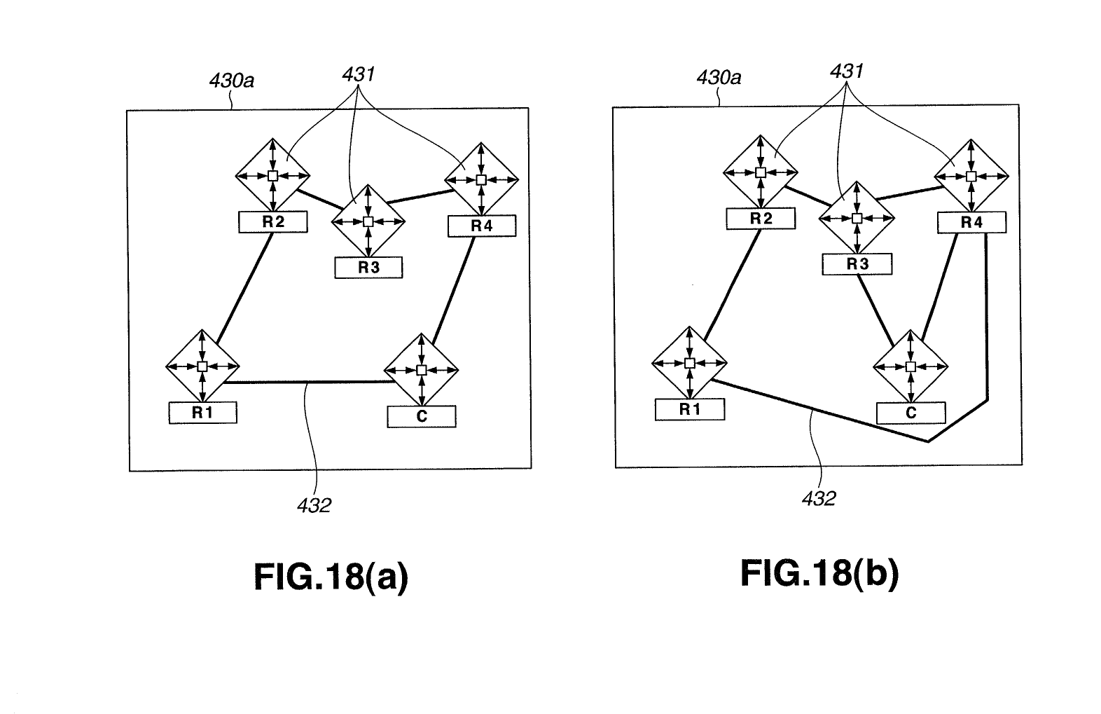

FIG. 18(a) shows an example display of the node icon display screen 430a in the normal connected state shown in the schematic connection diagram of FIG. 17(a), and FIG. 18(b) shows an example display of the node icon display screen 430a in the mis-connected state shown in the schematic connection diagram of FIG. 17(a).

It is seen from FIG. 18(a) that the line 432 indicating the connected state is connected in order of number of the node devices 100, and each node device 100 corresponding to the node icon 431 is normally connected.

Meanwhile, it is seen from FIG. 18(b) that the line 432 indicating the connected state is not connected in order of the numbers of the node devices 100, so that R3, C and R4 among the respective node devices 100 corresponding to the node icons 431 are mis-connected.

Thus, the sixth embodiment is configured in that the NMS 400 stores and manages the position information received from the respective node devices 100 being managed, generates node icons corresponding to the respective node devices 100, displays the node icons at the pertinent positions on the electronic map according to the position information about the pertinent node devices 100, and also displays lines indicating the connected state between the respective node icons. Therefore, the system manager on the side of the NMS 400 simply sees the display screen to easily find where the respective node devices 100 are located and also the connected state between the respective node devices 100, and can take steps to promptly work to restore the mis-connection.

In addition, it is to be understood that the present invention is not limited to the embodiments described above and also shown in the attached drawings, and can be executed by appropriately modifying without departing from the spirit and the scope of the invention.

For example, the aforementioned second to sixth embodiments were described in the respective embodiments as separately having a function of generating an internal operation clock of the node device 100, a function of automatically adjusting an antenna direction, a function of indicating node icons and a function of drawing a line indicating a node connected state according to the information generated by the GPS device 60, but it may be configured to have all of such functions.

In such a case, a mode which disposes the GPS antenna outdoor and inputs the GPS information received by the GPS antenna 61 to the GPS device 60 through the ODU 140, the coaxial cable 160 and the IDU 130 can be applied in the same way as in the first embodiment.

What is claimed is:

1. A radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein:
the node device comprises:
a GPS device for inputting GPS information which is sent from a GPS satellite and received by a GPS antenna;
transmission means for sending position information generated by the GPS device to the management device; and
control means for receiving a control signal generated by the management device according to the position information and controlling respective sections of the radio unit according to the control signal; and
the management device comprises:
control signal generation means which receives the position information from the node device and generates the control signal for controlling respective sections of the node device according to the position information; and
control signal transmission means which sends the generated control signal to a pertinent node device.

2. The radio communication system according to claim 1, wherein:
the radio unit is configured of an outdoor device disposed outdoors and an indoor device disposed indoors and connected to the outdoor device through a coaxial cable;
the GPS antenna is installed outdoors; and
the GPS information received by the GPS antenna is input to the GPS device via the outdoor device, the coaxial cable and the indoor device.

3. The radio communication device according to claim 2, wherein:
the outdoor device comprises multiple separation means which superimposes the GPS information received by the GPS antenna on a communication signal to an adjacent node device and sends to the coaxial cable; and
the indoor device comprises multiple separation means which separates the GPS information from the signal being sent through the coaxial cable and inputs to the GPS device.

4. The radio communication system according to claim 1, wherein the GPS antenna is installed indoors and the GPS information received by the PGS antenna is directly input to the GPS device.

5. The radio communication system according to claim 1, wherein the node device comprises clock generating means which receives a synchronization signal generated by the GPS device from time information which is contained in the GPS information and generates an internal operation clock of the own device according to the synchronization signal.

6. The radio communication device according to claim 5, wherein:
the node device comprises means for generating a self clock and means for extracting a clock from a radio communication channel in an associated section to take it as a line clock; and
the clock generation means comprises means for selecting one of the internal operation clock generated from the time information, the self clock and the line clock.

7. The radio communication system according to claim 1, wherein:
the control signal generation means comprises:
arithmetic means for calculating a direction of the antenna according to the position information received from each node device so that centers of antennas of the respective radio units of both of the mutually neighboring node devices are faced to each other; and
antenna direction adjusting control signal generation means for generating an antenna direction adjusting control signal for adjusting the antennas of the respective radio units of both of the node devices to direct them in the calculated antenna direction; and
the control means comprises:
antenna direction adjustment means for adjusting the direction of the antenna of the radio unit of the own node device according to the antenna direction adjusting control signal received from the management device.

8. The radio communication system according to claim 7, wherein:
the radio unit has azimuthal direction rotating means and elevational direction rotating means which respectively rotate the antenna in an azimuthal direction and an elevational direction; and
the antenna direction adjustment means comprises means for driving the azimuthal direction rotating means and the elevational direction rotating means to respectively rotate the antenna in the azimuthal direction and the elevational direction according to the antenna direction adjusting control signal.

9. The radio communication system according to claim 1, wherein:
the control signal generation means comprises:
radio level arithmetic means which calculates an optimum radio level of each radio unit of neighboring node devices corresponding to a distance between the neighboring node devices according to the position information received from the respective node devices; and
radio level adjusting control signal generation means which generates a radio level adjusting control signal for adjusting radio levels of the radio units of the neighboring node devices to the calculated radio levels respectively; and
the control means comprises radio level adjustment means which adjusts the radio level of the radio unit of the own node device according to the radio level adjusting control signal received from the management device.

10. The radio communication system according to claim 9, wherein the radio level is at least either one of the transmission level and the reception level.

11. The radio communication system according to claim 1, wherein the management device comprises:
a map database which stores electronic map data on an installation area of the node devices; and
display control means which displays node icons of the pertinent node devices at the pertinent positions on the electronic map according to the position information received from the node devices.

12. The radio communication system according to claim 11, wherein:
the node device comprises means for sending node identification information about the own device to the management device; and
the management device comprises means for displaying the node identification information together with node icons corresponding to the node devices according to the node identification information received from the node devices.

13. The radio communication system according to claim 11 or 12, wherein:
the node device comprises:
connection recognition means which recognizes a connected relation between the own node and an adjacent node device; and
connected state information transmission means which sends connected state information showing the recognized connected relation to the management device; and
the management device comprises:
connection management means which manages normal connected relation information between node devices being managed;
judging means which compares the connected state information received from the respective node devices and the connected state information managed by the connection management means and judges connected states between the respective node devices; and
connected state drawing means which draws lines indicating the connected states of the respective node devices between node icons corresponding to the respective node devices according to the judged result obtained by the judging means.

14. The radio communication system according to claim 13, further comprising means for alarming a mis-connected state when the judging means judges that the respective node devices are in the mis-connected state.

15. The radio communication system according to claim 1, wherein the node device is an ATM communication device for communicating by an asynchronous transfer mode (ATM) transmission system, and the entire network is configured by an ATM network.

16. A radio communication system which disposes a plurality of node devices each provided with a radio unit which includes an outdoor device installed outdoors and an indoor device installed indoors and connected to the outdoor device through a coaxial cable and, realizes communications between the respective node devices as the respective node devices perform radio communications with neighboring node devices; wherein:
the node device comprises a GPS device which inputs GPS information sent from a GPS satellite and received by a GPS antenna;
the GPS antenna is installed outdoors; and
the GPS information received by the GPS antenna is input to the GPS device through the outdoor device, the coaxial cable and the indoor device.

17. The radio communication system according to claim 16, wherein:
the outdoor device comprises multiple separation means which superimposes the GPS information received by the GPS antenna on a communication signal with the neighboring node device and sends to the coaxial cable; and
the indoor device comprises multiple separation means which separates the GPS information from the signal being sent through the coaxial cable and inputs to the GPS device.

18. A radio communication system which disposes a plurality of node devices having a radio unit and performs radio communications of the respective node devices with their neighboring node devices to realize the communications among the respective node devices, wherein:
the node device comprises:
a GPS device which inputs GPS information received from a GPS satellite; and
clock generation means which generates an internal operation clock of the own device according to a synchronization signal generated from time information contained in the GPS information by the GPS device.

19. The radio communication system according to claim 18, wherein:
the node device comprises means for generating a self clock and means for extracting a clock from a radio communication channel between associated sections to take as a line clock; and
the clock generating means comprises means for selecting either one of the internal operation clock generated from the time information, the self clock and the line clock.

20. A radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein:
the node device comprises:
a GPS device which inputs GPS information received from a GPS satellite;
transmission means which sends position information generated by the GPS device to the management device; and
antenna direction adjusting means which adjusts a direction of the antenna of the radio unit of the own node device according to antenna direction adjusting control signal generated by the management device according to the position information; and
the management device comprises:
arithmetic means which calculates directions of the antennas according to the position information received from the respective node devices so that centers of the antennas of the respective radio units of both of the mutually neighboring node devices are faced to each other;
antenna direction adjusting control signal generation means which generates the antenna direction adjusting control signal for adjusting the antennas of the respective radio units of both of the node devices to face them in the calculated antenna direction; and
control signal transmission means which sends the generated antenna direction adjusting control signal to the pertinent node devices.

21. The radio communication system according to claim 20, wherein:
the radio unit has azimuthal direction rotating means and elevational direction rotating means which respectively rotate the antenna in an azimuthal direction and an elevational direction; and
the antenna direction adjustment means comprises means for driving the azimuthal direction rotating means and the elevational direction rotating means to respectively rotate the antenna in the azimuthal direction and the elevational direction according to the antenna direction adjusting control signal.

22. A radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein:
the node device comprises:
a GPS device which inputs GPS information received from a GPS satellite;
transmission means which sends position information generated by the GPS device to the management device; and
radio level adjusting means which adjusts a radio level of the radio unit of the own node device according to a radio level adjusting control signal generated by the management device according to the position information; and
the management means comprises:
radio level arithmetic means which calculates an optimum radio level of the respective radio units of both of the node devices corresponding to a distance between both of the node devices according to the position information received from the respective node devices;
radio level adjusting control signal generation means which generates the radio level adjusting control signal for adjusting the radio levels of the radio units of both of the node devices to the calculated radio level respectively; and
control signal transmission means which sends the generated antenna direction adjusting control signal to the pertinent node devices.

23. The radio communication system according to claim 22, wherein the radio level is at least either one of the transmission level and the reception level.

24. A radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein:
the node device comprises:
a GPS device which inputs GPS information received from a GPS satellite; and
transmission means which sends position information generated by the GPS device to the management device; and
the management device comprises:
a map database which stores electronic map data on an installation area of the node devices; and
display control means which displays node icons of the pertinent node devices at pertinent positions on the electronic map according to the position information received from the node devices.

25. The radio communication system according to claim 24, wherein:
the node device are further comprises means for transmitting node identification information on the own device to the management device; and
the management device comprises means for displaying the node identification information together with node icons corresponding to the node devices according to the node identification information received from the node devices.

26. A radio communication system comprising a network structure which arranges a plurality of node devices each having a radio unit and performs radio communications of the respective node devices with their neighboring node devices to realize the communications among the respective node devices, and a management device for managing the network via at least one of the node devices, wherein:
the node device comprises:
a GPS device which inputs GPS information received from a GPS satellite;
connection recognition means which recognizes a connected relation between the own node and the adjacent node devices;
transmission means which transmits position information generated by the GPS device and connected state information showing a connected relation recognized by the connection recognition means to the management device;
the management device comprises:
a map database which stores electronic map data about an installation area of the node devices;
display control means which displays node icons of the pertinent node devices at the pertinent positions on the electronic map according to the position information received from the node devices;
connection management means which manages normal connected relation information between the node devices being managed;
judging means which compares the connected state information received from the respective node devices and the connected state information managed by the connection management means and judges connected states between the respective node devices; and
connected state drawing means which draws lines indicating the connected states of the respective node devices between the node icons corresponding to the respective node devices according to the judged result obtained by the judgment means.

27. The radio communication system according to claim 26, wherein:
the node device further comprises means for transmitting node identification information about the own device to the management device; and
the management device comprises means for displaying the node identification information together with the node icons corresponding to the pertinent node devices according to the node identification information received from the node devices.

28. The radio communication system according to claim 26 or 27, further comprising means for alarming a mis-connected state when the judging means judges that the respective node devices are in the mis-connected state.
